(19) United States
(12) Patent Application Publication
(10) Pub. No.: US 2017/0009524 A1
(43) Pub. Date: Jan. 12, 2017

(54) RETRACTABLE CURTAIN PANEL AND ENHANCED STIFFENERS

(71) Applicant: Rajiva A. Dwarka, Boston, MA (US)

(72) Inventor: Rajiva A. Dwarka, Boston, MA (US)

(21) Appl. No.: 15/209,462

(22) Filed: Jul. 13, 2016

Related U.S. Application Data
(63) Continuation-in-part of application No. 15/144,746, filed on May 2, 2016.
Application No. 15/144,746 is a continuation-in-part of application No. 13/594,091, filed on Aug. 24, 2012, now Pat. No. 9,347,258.
Application No. 13/594,091 is a continuation-in-part of application No. 13/469,496, filed on May 11, 2012, now abandoned.
(60) Provisional application No. 61/484,930, filed on May 11, 2011.
(60) Provisional application No. 61/587,788, filed on Jan. 18, 2012.
(60) Provisional application No. 61/527,765, filed on Aug. 26, 2011.
(60) Provisional application No. 62/191,692, filed on Jul. 13, 2015.

(51) Int. Cl. E06B 9/58; E06B 9/42

(52) U.S. Cl. CPC E06B 9/581; E06B 9/42; E06B 2009/587; E06B 2009/2452

(57) ABSTRACT

According to some aspects, provided are curtain assemblies configured to operate in high wind environments. The curtain assembly can include first and second track guide including internal security rails. The internal securing rails moveably engage end portions of fabric stiffeners to provide stability in the curtain. In some embodiments, the securing rails include ramp portions to accommodate drift in the curtain and/or fabric stiffeners without compromising operation of the curtain.

### RELATED APPLICATIONS

This application is a continuation-in-part and claims priority under 35 U.S.C. §120 to U.S. patent application Ser. No. 15/144,746 entitled “RETRACTABLE CURTAIN PANEL WITH TRACK GUIDE,” filed May 2, 2016, which is a continuation of and claims priority under 35 U.S.C. §120 to U.S. patent application Ser. No. 13/594,091, entitled “RETRACTABLE CURTAIN PANEL WITH TRACK GUIDE,” filed on Aug. 24, 2012 which is a continuation-in-part of and claims priority to U.S. patent application Ser. No. 13/469,496 entitled “RETRACTABLE CURTAIN PANEL WITH TRACK GUIDE,” filed on May 11, 2012 which claims priority under 35 U.S.C. §119(e) to U.S. Provisional Application Ser. No. 61/484,930 entitled “RETRACTABLE CURTAIN PANEL WITH TRACK GUIDE,” filed May 11, 2011; U.S. patent application Ser. No. 13/594,091 also claims priority under 35 U.S.C. §119(e) to U.S. Provisional Application Ser. No. 61/527,765 entitled “RETRACTABLE CURTAIN PANEL WITH TRACK GUIDE,” filed Aug. 26, 2011 and claims priority under 35 U.S.C. §119(e) to U.S. Provisional Application Ser. No. 61/587,788 entitled “RETRACTABLE CURTAIN PANEL WITH TRACK GUIDE,” filed Jan. 18, 2012, all of which applications are incorporated herein by reference in their entirety.

### BACKGROUND

Traditional window curtain installations are configured to provide for both functional and aesthetic purposes. In a conventional curtain, one functional goal is to reduce light impinging upon dwelling areas or other interior spaces coming from exterior windows. Other functions include providing for removal of the shading portions of the curtain to allow more light as desired. In some examples, this can be accomplished by winding a curtain around a roller operated by hand via a draw cord. An operator can raise or lower a curtain depending upon, for example, a desired amount of light. In other examples, the roller can be operated via a motor to raise and lower the curtain, covering exterior facing windows to any desired degree.

Typically, consumers select curtains based not only on the functional aspects provided, but also based on the aesthetic of the curtain. In some situations the physical layout of a space (e.g., a building home or office) dictates the shape and configuration of a given curtain. Whether the space is in an interior or exterior location can affect physical constraints.

### SUMMARY

Accordingly there is provided a retractable curtain assembly for installation in exterior locations that are secure against exterior weather conditions (e.g., high wind forces). In one embodiment, the retractable curtain assembly is configured for operation of a curtain subject to strong wind forces (e.g., 10, 20, 30, 40 mile per hour winds and gusts exceeding 40 miles per hour). The curtain can be manipulated between an open position where the curtain is recessed and the opening on which the curtain is installed and visible and a closed position wherein the curtain is extended to cover an opening or shield and enclosure from wind. The curtain can also be manipulated to occupy various positions between the open and closed positions. A track guide can be constructed to hold the curtain in place during operation, enabling transition between the closed and open position, for example, where the assembly is expected to be subject to high winds (e.g., 10, 20, 30 mile per hour winds and gusts exceeding 30 miles per hour). The track guide and/or track insert can be constructed and arranged to mate with stiffener structures built into the curtain to accommodate high wind environments.

In one example, the track guide is constructed to hold and support the stiffeners. In further example, the stiffeners are constructed and arranged on the curtain at irregular intervals to maximize the strength of the stiffener members while maintaining the ability to roll the curtain (and stiffeners) around a roll tube. For example, as the curtain is wound around the roll tube the stiffeners are likewise wound around the roll tube. In some embodiments, the stiffeners are spaced at irregular intervals or with other spacing configured to ensure that overlap of the stiffeners is minimized when would around the roll tube. In some implementations, the sizing of the head box (retaining structures for the roll tube and curtain) requires that no overlap of the stiffeners occurs when winging the curtain around the roll tube. In some examples, overlap of the stiffeners will prevent further rotation of the roll tube in the head box rendering such a curtain assembly non-functional or result in binding of the curtain during operation.

In some embodiments, the track guide includes an entry guide constructed to receive the stiffeners as the stiffeners come off of the roll tube and travel into the track guide. In some embodiments, the entry guide comprises pair members that operate on opposed sides of the stiffeners at a connection element. In some examples, the entry guide includes respective ramp portions constructed and arranged to enable variation in the position of the stiffeners as they are wound out of the roll tube and into the track guide. In further examples, the assembly can include a track ramp that extends outward from the track guide constructed and arranged to guide the stiffeners into the entry guide. The entry guide facilitates mating between end portions of the stiffeners with securing rails the can extend the length of the track guide. In some embodiments, the securing rails include a ramp or curved portion at one end and thus form the entry guide and securing rail. In further examples, entry guides and securing rails are disposed on either side of a plurality of fabric stiffeners. The ramp portions operate to guide a smaller circumference portion a locking pin into a secured operating channel.

In one embodiment, the curtain assembly further comprises a bottom rail connected to at least one of the first and second curtains. In one embodiment, the bottom rail includes a length adjustment channel. In one embodiment, a curtain is connected to a bar within the bottom rail, wherein the bar is constructed and arranged to travel within the adjustment channel. In one embodiment, the bar is weighted to pull excess length of a connected curtain into the adjustment channel.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed below with reference to the accompanying Appendixes. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. In the figures:

FIGS. 1A-C illustrate example portions of a curtain stiffener and track guide, according to some embodiments;

FIG. 1D illustrates an example curtain assembly according to one embodiment;

FIG. 2 illustrates an example track assembly includes a track guide, according to one embodiment;

FIG. 3 illustrates an example curtain assembly in a side view installed and operable along a slope, according to one embodiment;

FIG. 4 illustrates an example curtain assembly constructed and arranged to cover irregularly shaped openings, according to one embodiment;

FIG. 5 illustrates an example track assembly according to one embodiment;

FIGS. 6A-B illustrates an example expandable bottom rail according to one embodiment;

FIGS. 7A-B illustrate a perspective view and front view of a curtain assembly according to one embodiment;

FIG. 8 illustrates an example of a curtain assembly, according to one embodiment;

FIGS. 9A-C illustrate components of a curtain assembly, according to one embodiment;

FIGS. 10A-E illustrate example components of a curtain assembly, according to one embodiment;

FIGS. 11A-B illustrate example embodiments curtain assemblies including multiple curtains;

FIG. 12 illustrates an example implementation of a curtain assembly having multiple curtains, according to one embodiment;

FIG. 13 illustrates an example track assembly, according to one embodiment;

FIG. 14 illustrates structures for an example curtain assembly, according to one embodiment;

FIGS. 15A-B illustrate frontal views of example curtain assemblies, according to some embodiments;

FIG. 16 illustrates an example of a multi-curtain curtain assembly, according to one embodiment;

FIG. 17 illustrates structures for an example curtain assembly, according to one embodiment;

FIG. 18 illustrates structures for an example curtain assembly, according to one embodiment;

FIG. 19 illustrates structures for an example curtain assembly, according to one embodiment;

FIG. 20 illustrates structures for an example curtain assembly, according to one embodiment; and

FIG. 21 illustrates structures for an example fabric stiffener, according to one embodiment.

### DETAILED DESCRIPTION

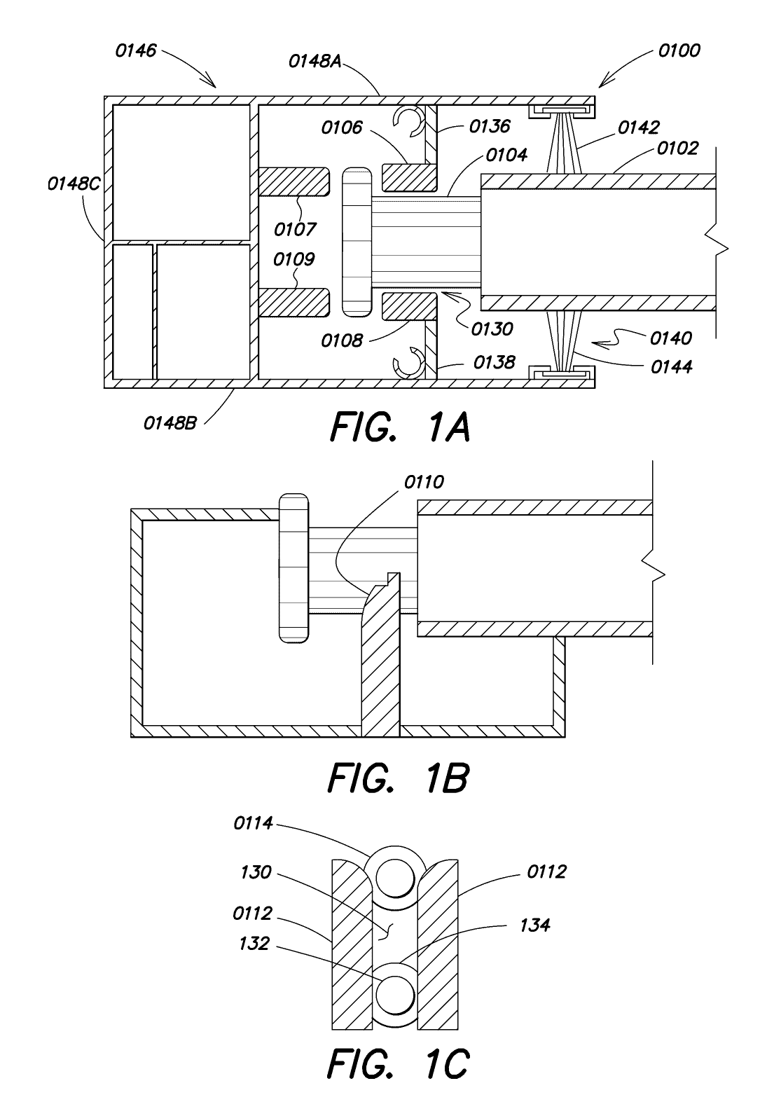

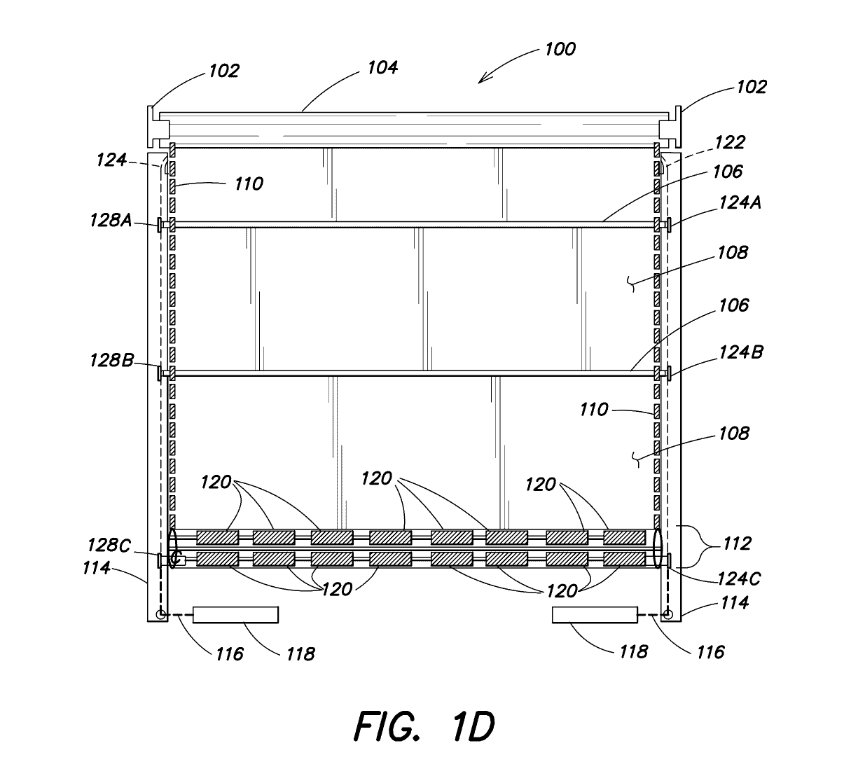

FIGS. 1A-D and 17-21 illustrates various embodiments of a roll up curtain (e.g., fabric or vinyl) panel system that is constructed to provide weather protection, for example, in high wind environments. The roll up curtain system is constructed and arranged to incorporate enhanced thickness of fabric curtains and incorporate stronger fabric stiffeners, where for example the fabric stiffeners are constructed of metal or plastic tubes (e.g., hollow cylinder). The stiffeners can be constructed and arranged on the curtain at irregular or other spacing intervals to maximize the strength/support provided by the stiffener members while maintaining the ability to roll the curtain (and stiffeners) around a roll tube.

The stiffeners can include locking pins on each end of the stiffener. The locking pins are constructed to moveably engage track guides on either side of the curtain. In one example, the locking pins having a large circumference end portion and smaller circumference inner portion. The track guide can mate with the smaller circumference inner portion to hold a fabric stiffener in place against horizontal movement, and the larger circumference end portion can also mate with the track guide to hold the fabric stiffener in place against longitudinal movement (e.g., into and out of the track guide along the plane of the stiffener) According to one embodiment, paired vertical track guides (e.g., left and right side) hold the stiffeners in respective tracks of the guide as the curtain moves between open and recessed positions. In one example, locking pins on the right and left side of the stiffeners engage respective right and left side track guides. In further examples, the locking pins of the stiffeners engage paired securing rails within the left and right track guides.

As the curtain is rolled around the roll tube, the stiffeners leave the tracks of the track guides and are wound around the roll tube. As the curtain is unwound the stiffeners must mate with the respective tracks. In some embodiments, entry guides are disposed within the tracks to provide a ramp for the end lock pins of the stiffener. In one embodiment, the entry guides are constructed of pairs of securing rails that extend the length of the track within the track guides. In one example, each of the securing rails has a curved portion where the stiffeners first meet with the track guide as the curtain travels along the track guide. The curved portion is configured to guide the locking pins of the stiffeners into the respective tracks of the track guides.

Stiffeners can be constructed of various materials, including metal bands fixed to one or more sides of the curtain. Application Serial No. 12/911,807, entitled ARCHITECTURAL APPARATUS AND METHOD, filed on Oct. 26, 2010, now U.S. Pat. No. 8,408,278 incorporated by reference herein by reference in its entirety, describes examples of banding constructed about fabric curtains that provide rigidity and support for the curtains of various curtain assemblies.

FIGS. 1A-C are example embodiments of a section of a curtain stiffener and one side of a guide track. The one side of the guide track can be constructed with a squared U shape exterior (when viewed in cross section). Depending how the curtain assembly is installed, side 148A can face in the same direction as the front of the curtain, side 148B can face in the same direction as the back of the curtain, and side 148C connects sides 148A-B. Shown at 0100 is an embodiment of a stiffener 0102 having an end lock track pin 0104. The track in 0104 is held in position by paired securing rails 0106 and 0108. Each of the securing rails (e.g., 0106 and 108) can include a notched or ramp region at the top of the guide track where the stiffener (e.g., 0102) and/or track pin (e.g., 0104) would enter the track. The securing rails 0106 and 0108 can extend from a first flange 0136 and a second flange 0138 respectively. The flanges extend into an open operating channel 0140 defined by the track guide. In another example, brush portions (e.g., 0142 and 0144) may also extend into the open operating channel 0140 to engage a curtain and stiffeners during operation.

Shown in FIG. 1B is an example of a notched or ramp region 0110. The notched or ramp region 0110 is constructed and arranged to guide the track pin (e.g., 0104) of a stiffener so that the curtain and stiffeners will engage the securing rails and operate within the track guide to increase stability in the curtain of the curtain assembly. The ramp structures (e.g., 0110) engage the track pin or locking pin (e.g., 0104) of the fabric stiffeners and continue to engage via securing rails (e.g., 0106 and 0108) as the curtain is operated between open and closed positions. In on example, the ramp portion provides curvature in one direction. Referring to FIG. 1A each of the ramp portions may be constructed so that the curvature of the ramp portions are directed towards the secured operating channel 0130. In another example, the ramp portions may be constructed so that the curvature of the ramp portions are directed towards the left side of the Figure as shown. In further example, the ramp portion may be constructed with curvature resembling a portion of a sphere (e.g., an ⅛ portion of a sphere) so that the ramp portion provides for tolerance in multiple directions.

According to one embodiment, the ramp structures facilitate the operation of the curtain, and can be configured to do so in high wind environments. For example, as the locking pin is unwound from the roll tube there is a gap in which the locking pin has not yet engaged either the ramp structure of securing rails. When subject to high winds the curtain operates as a sail and can deflect the stiffeners and locking pins from engage properly with the guide track. The ramp region (e.g., 0110) enable proper engagement of the locking pin even where the locking pins have been deflected from their proper operating path. As the locking pins engage the ramp structure, they are guided onto the securing rails (e.g., 0106 and 0108). The ramp structure and securing rails can be constructed so that upon engagement, the stiffeners are subject to a force pulling towards the respective ends of stiffeners, thereby increasing stability and decreasing deflection of the curtain in high winds.

FIGS. 1A-B are illustrated with example dimensions according to one embodiment, however, in other embodiments, different dimensions are employed. FIG. 1C illustrates another embodiment of a track pin 0114 and securing rails 0112 constructed and arranged to provide tolerance in the docking of the track pins into the guide track. In one embodiment, the track pin or locking pin comprises cylindrical portions of two circumferences. An end portion 134 is constructed with a larger circumference and an inner portion 132 is constructed with a smaller circumference that is size to moveably engage securing rails and enable operation (e.g., open and close the curtain) within the secured operating channel 130. In other embodiments, the locking pins can include other configurations. For example, the locking pin can be constructed as a t shaped structure or other structure that can be guided an entry guide and secure a fabric stiffener into the secured operating channel.

Returning to FIG. 1A, optional securing rails 0107 and 0109 can be included in the track guide to further reduce lateral movement of the stiffeners during operation, and/or when the curtain is subject to wind or other forces. The optional securing rails can include notched or ramped portions as discussed above.

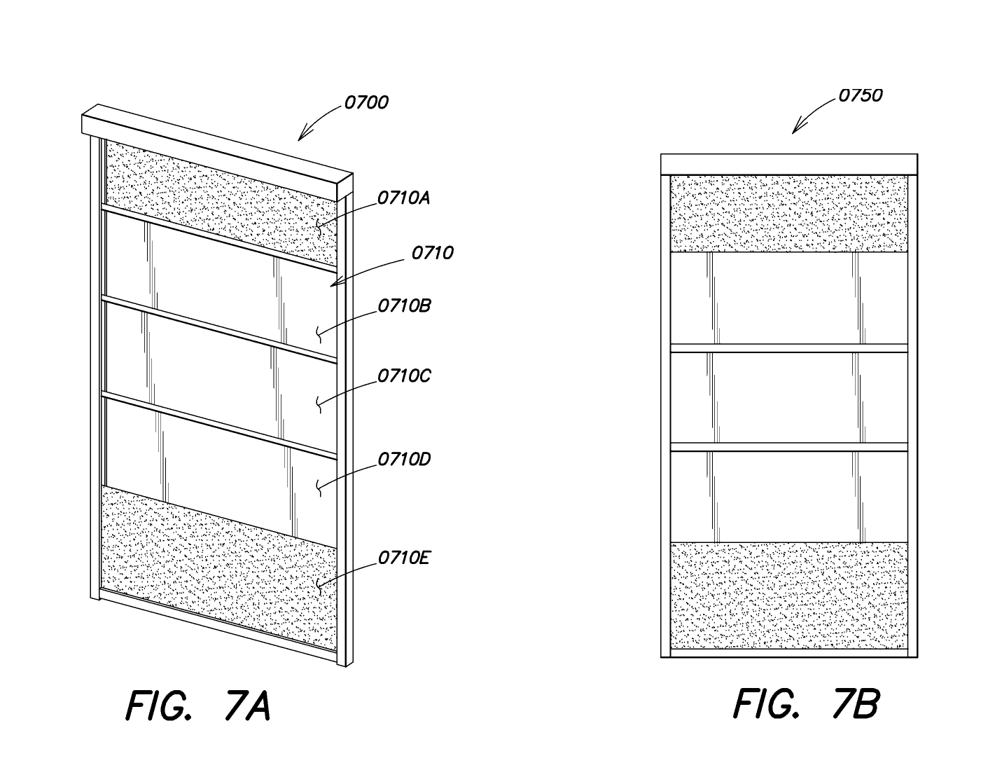

FIGS. 7A and 7B show a perspective view 700 and front view 750 of one embodiment of a curtain assembly. The curtain assembly is specially configured to high wind environments, where the curtain (e.g., 710) can be constructed of vinyl, or heavy fabric, or panel sections (e.g., 710A-E) of vinyl and fabric where the curtain or panel sections are impermeable to wind. In one embodiment, high wind environments (including, e.g., 20, 30, and over 40 mph winds) mandate dimensions and spacing of stiffeners for the curtain assembly. In one example, a roll tube of 70-85 mm diameter is selected with four fabric or 5 stiffeners of ½″ diameter. In an environment with winds up to 40+ mph, one example embodiment specifies that the maximum width of the curtain assembly should be less than or equal to 15′ with a maximum height of equal or less than 12′. In other embodiments, 15′ and 12′ may be exceeded, in one example, up to on half a foot in each direction without compromising wind capacity.

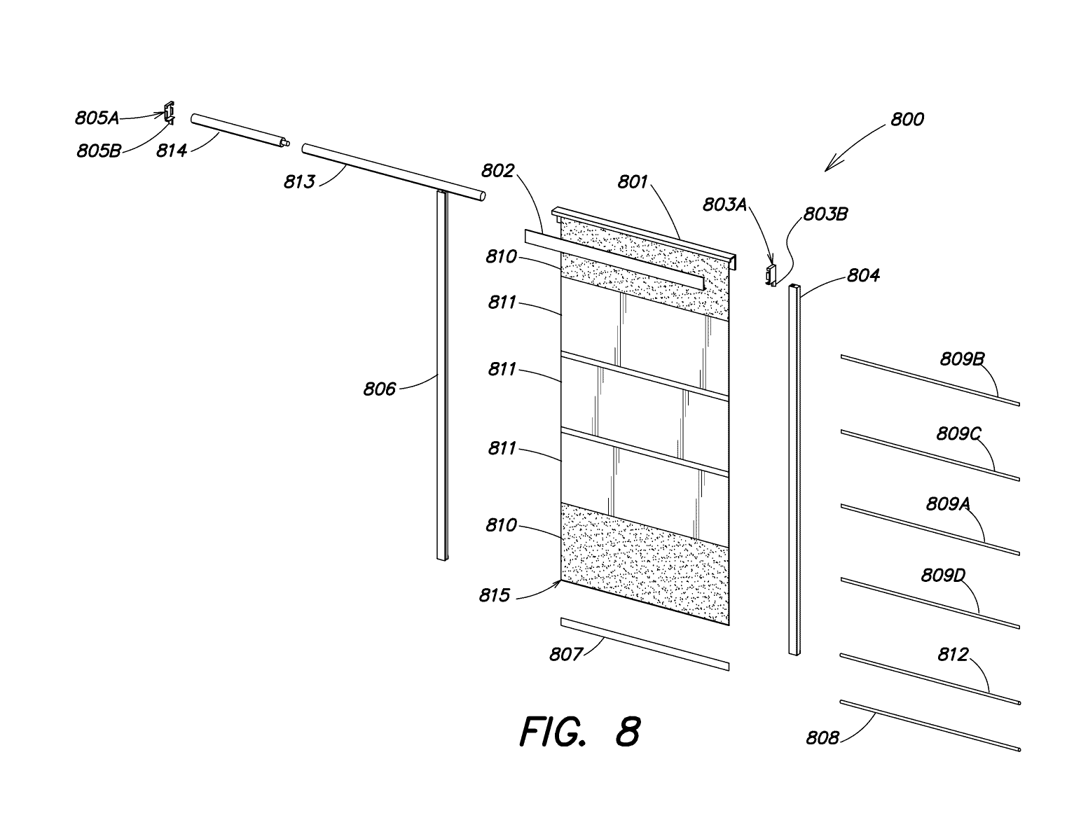

FIG. 8 illustrates components of the one embodiment of a curtain assembly 800. At 801 and 802 is the headbox and head box cover that house the roll tube 813 for winding the curtain, and the motor housing 814 that operates the roll tube 813 to wind and unwind the curtain 815. The headbox can be constructed to mate with a right (e.g., 803A) and left (e.g., 805A) end cap. The end caps can each be constructed with a lower protrusion or flange (e.g., 803B and 805B) that mates with a left and right track respectively (e.g., 806 (left track) and 804 (right track)). The curtain assembly can include a bottom weighted bar or a hem bar 807. The hem bar con be configured to facilitate unwind the curtain 815. In one example the hem bar 807 can include an hem bar gasket 808 constructed to provide weight to facilitate movement of the curtain. Discussed in greater detail below the gasket 808 can be constructed to facilitate a wind tight seal between the bottom of the curtain 815 and an abutting surface. In another embodiment, the hem bar can include a hem bar spline 812 that secures the curtain 815 to the hem bar 807. In one example, the hem bar spline can include locking pins that engage the tracks and securing rails disposed in the tracks.

At 809A-D are fabric stiffeners having locking pins at their respective ends for engaging the tracks (e.g., 804 and 806) at securing rails (not shown). The fabric stiffeners can be attached to the curtain 815 and can also be inserted in pockets formed the curtain 815 to receive the fabric stiffeners. In some embodiments, the curtain 815 can be constructed of panels of different material (e.g., 810 fabric panels and 811 vinyl panels).

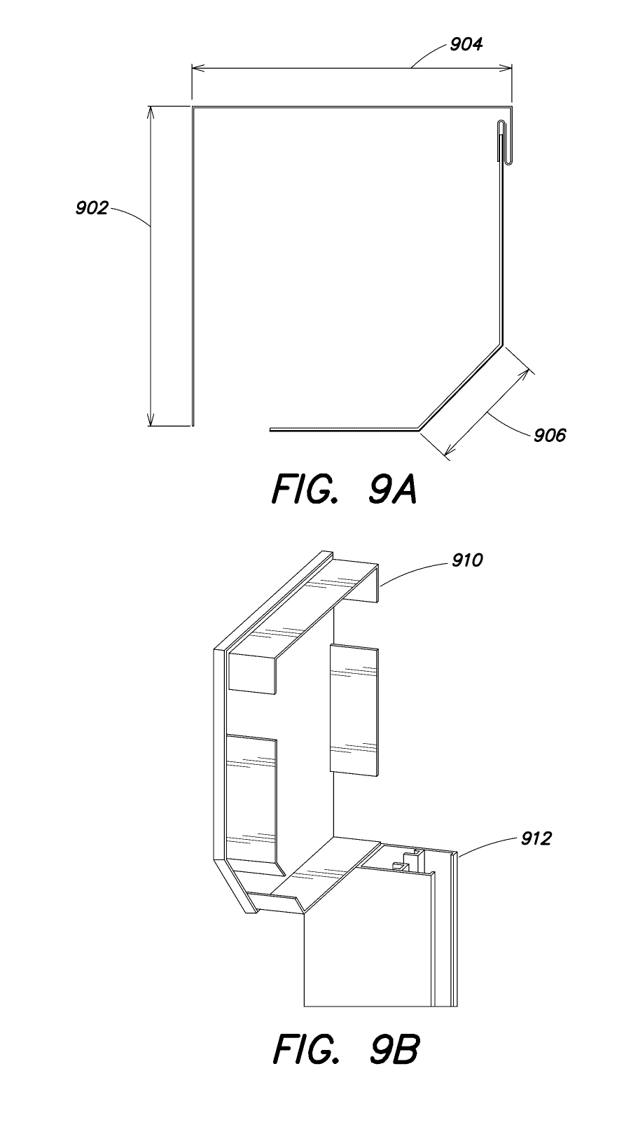

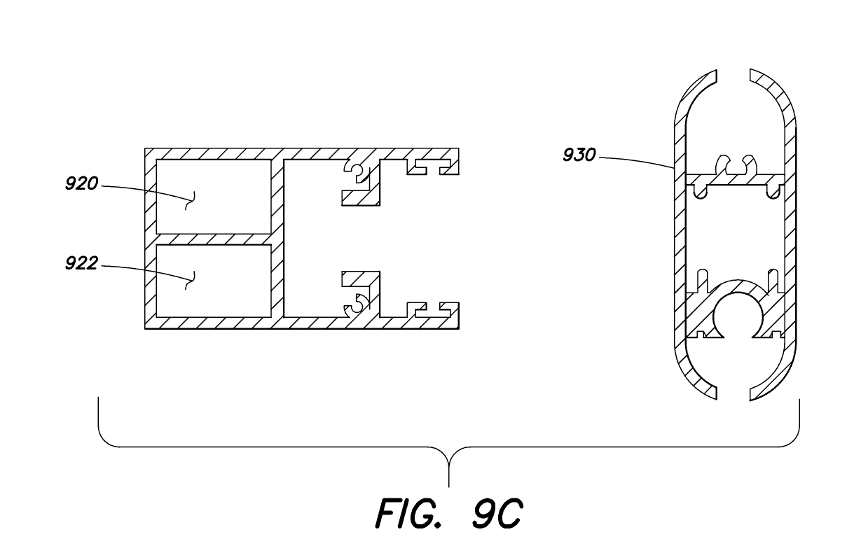

FIG. 9A illustrates an example headbox and various dimensions. For example, the height (e.g., 902) and width (e.g., 904) can be up to six inches to accommodate curtain assemblies having heights up to 120″. The height and width can be increased to seven inches to accommodate curtain assemblies from approximately 121″-144″. With a six inches height and width a front angle portion of the head box assembly can be two and 5/16^{th} inches. FIG. 9B shows a track supporting end cap 910 and track 912. As shown in FIG. 8, the end cap can include a lower protrusion or flange that mates internally with one of securing channels in the track 812 (see FIG. 9C 920, 922). In one embodiment, the track can be constructed with securing channels having an outer dimension of one and half inches together, and the track can be two and five eighths inches across. Also shown in FIG. 9C is a cross section of an example hem bar 930. In one example, the hem bar is two and eleven sixteenth inches high and one inch wide.

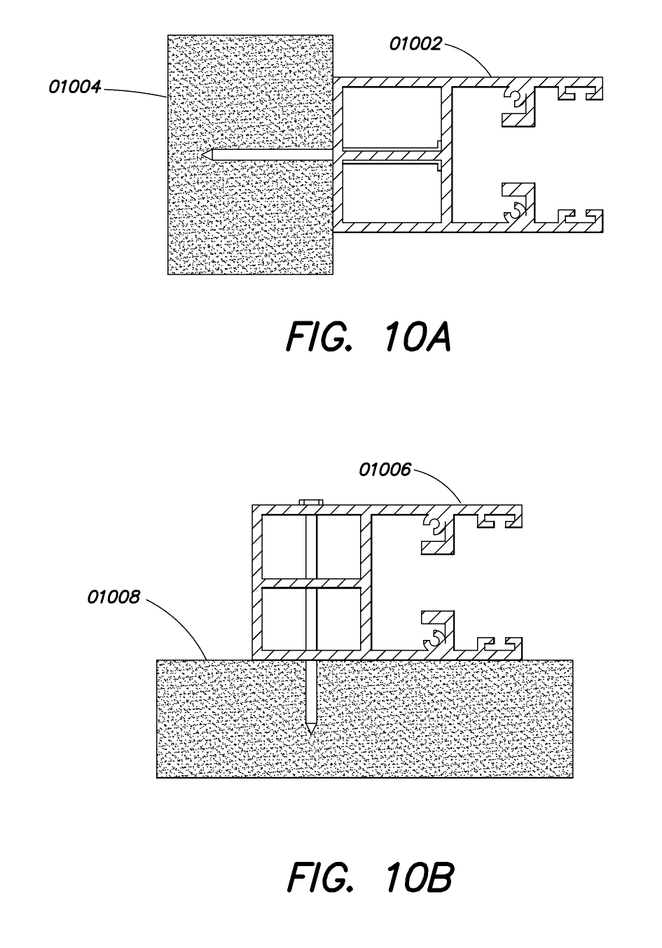

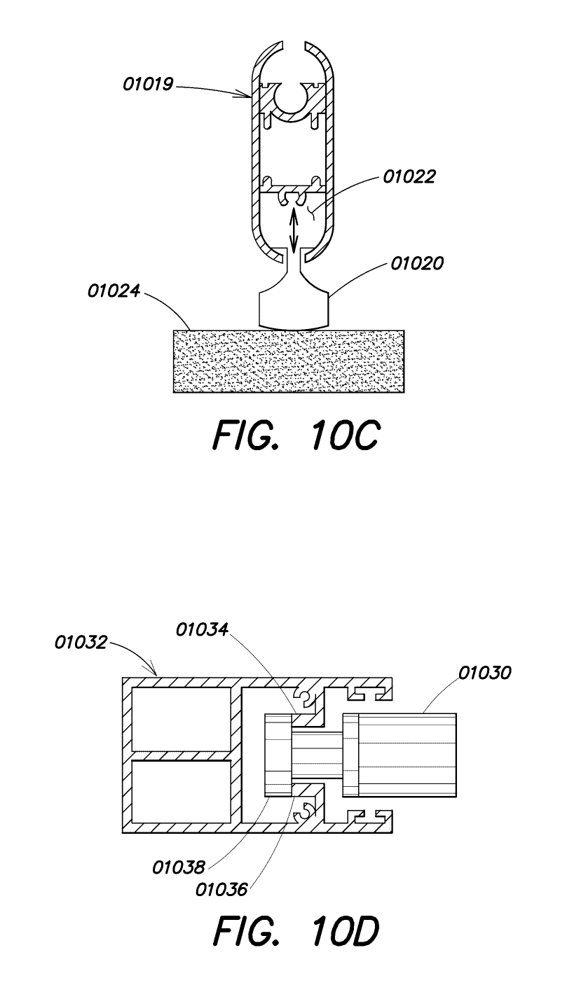

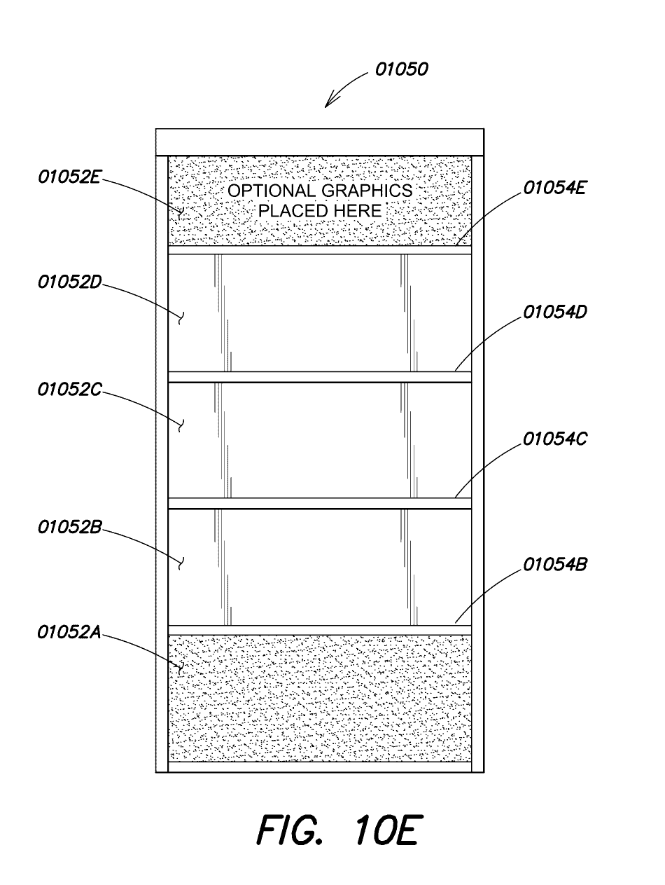

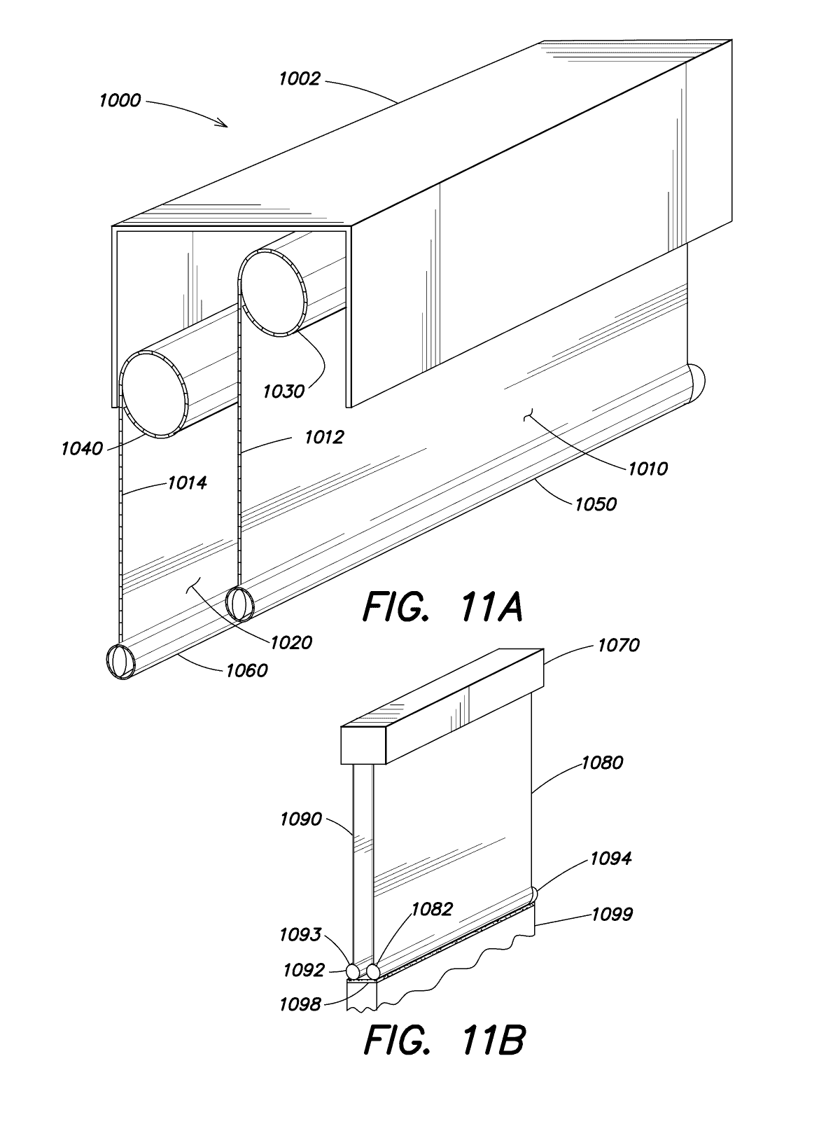

FIGS. 10A and 10B illustrate options for installing tracks (1002 and 1006) of embodiments of a curtain assembly on a respective surface (e.g., 1004 and 1008). FIG. 10C illustrates a cross section view of a hem bar 1019 and gasket 1020. The gasket and hem bar are constructed to permit movement of the gasket 1020 into an out of channel 1022, which allows for variation in an abutting surface 1024 while maintaining a seal.

FIG. 10D illustrates another embodiment of a fabric stiffener 1030 guided in a track 1032. The stiffener 1030 engages the track 1032 at securing rails 1034 and 1036 via locking pin 1038.

FIG. 10E illustrates another embodiment of a curtain 1050, wherein curtain panels A-E can be secured to each other. The panels can include fabric stiffeners, and may also include banding across the curtain (e.g., 1054B-E). The banding can be constructed to help secure the panels to each other and to secure the fabric stiffeners. In other examples, the banding can comprises the fabric stiffeners. FIG. 10E also illustrates an example spacing for the panels of the curtain 1050 (e.g., 1052E—28″+/−4″, 1052D-B—of 28″, and 1052A—32″+/−4″. The spacing of the panels can be constructed to withstand wind forces of up to, for example, 20, 30 and 40 mph winds, while preserving spacing on the roll tube such that the fabric stiffeners do not overlap to increase a width of the wound curtain.

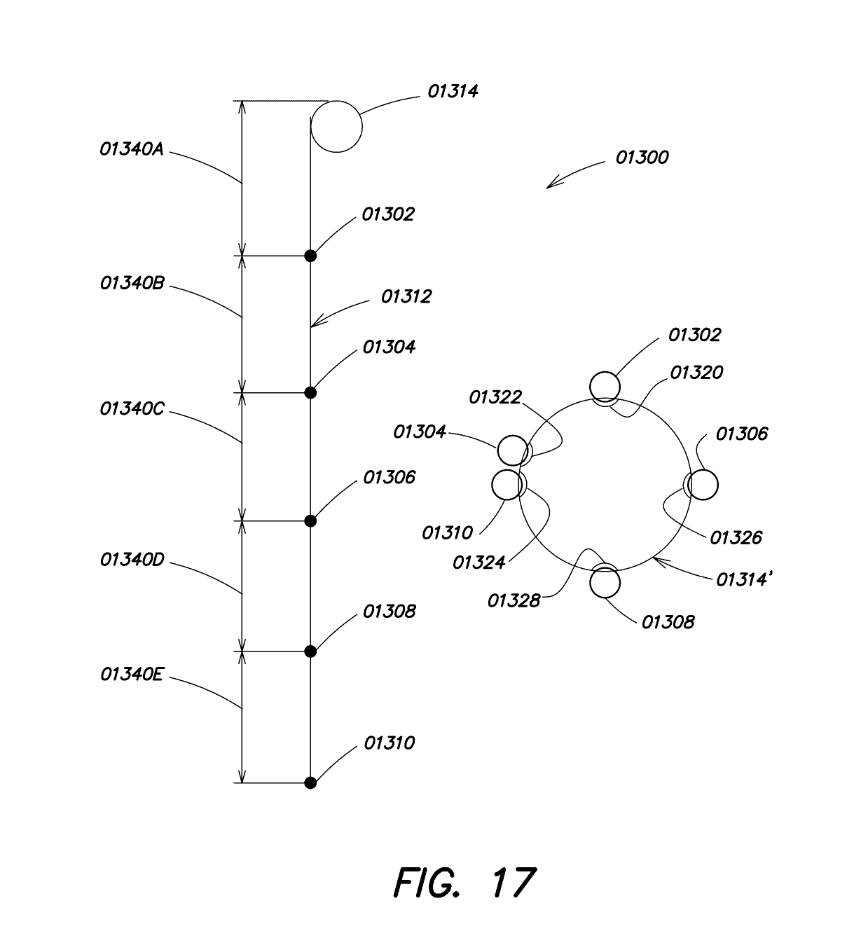

FIG. 17 illustrates an example embodiment of a curtain assembly 01300 including fabric stiffeners 01302-01310. The stiffeners can be cylindrical tubes (e.g., of ½″ diameter). In one embodiments, the spacing between the stiffeners (and respective pockets in the curtain 01312 is constructed to ensure that when wound around the roll tube 01314 the respective stiffeners do not overlap. In some settings the size of structures in which the roll tube and curtain are housed must be minimized, thus, overlapping stiffeners can comprise the function of the curtain assembly. To provide additional sizing tolerance, in another embodiment roll tube 01314′ can include optional recesses (e.g., 01320-01328) running along the roll tube that mate with the fabric stiffeners when the curtain is roll around the roll tube. Shown with 01314′ are the positions stiffeners 01302-01310 attain once wound around the roll tube.

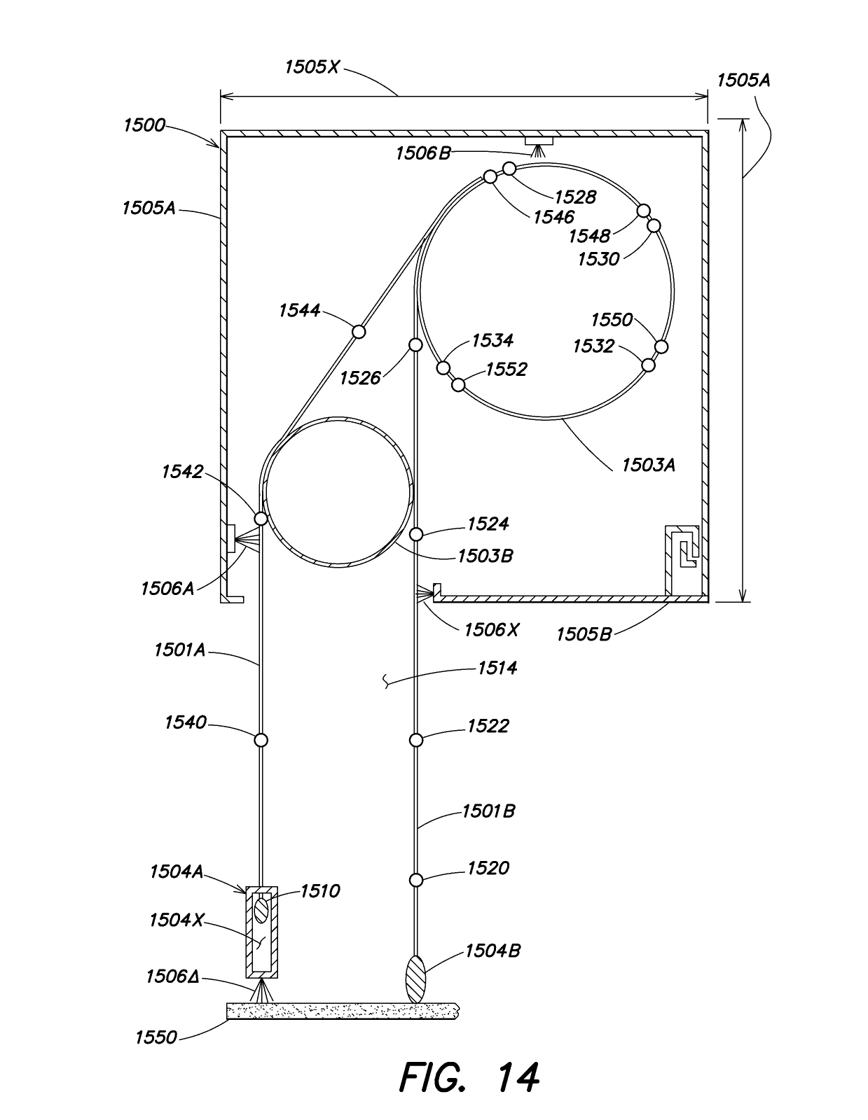

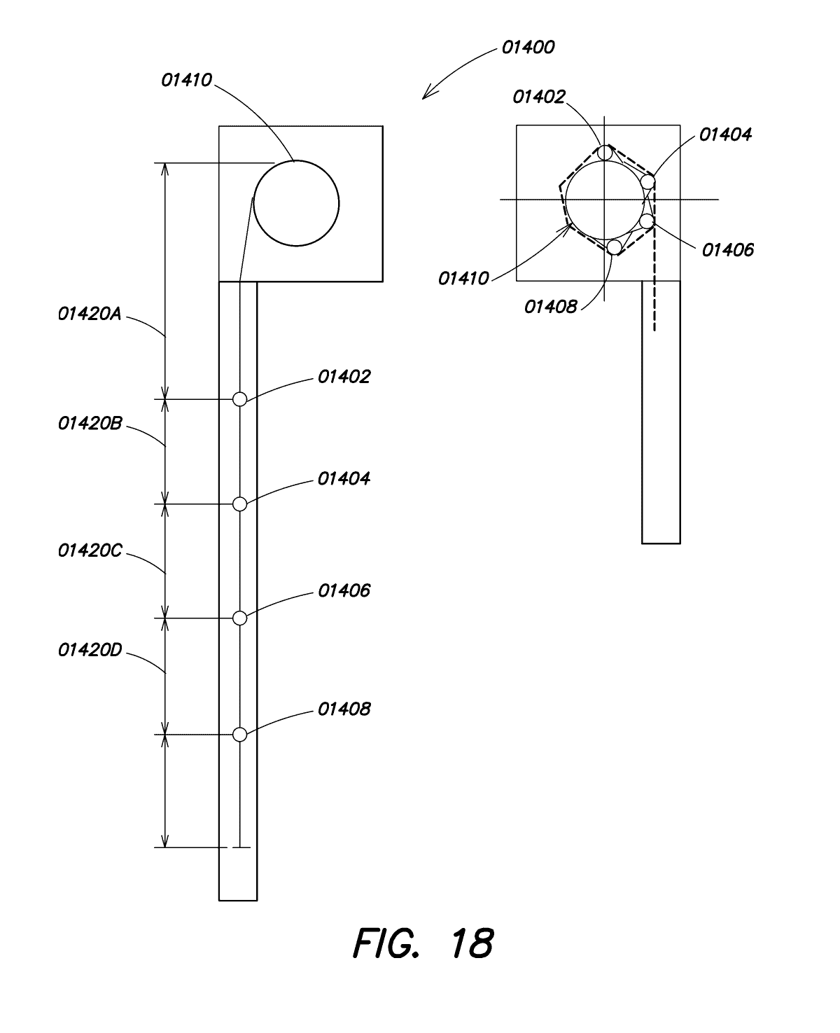

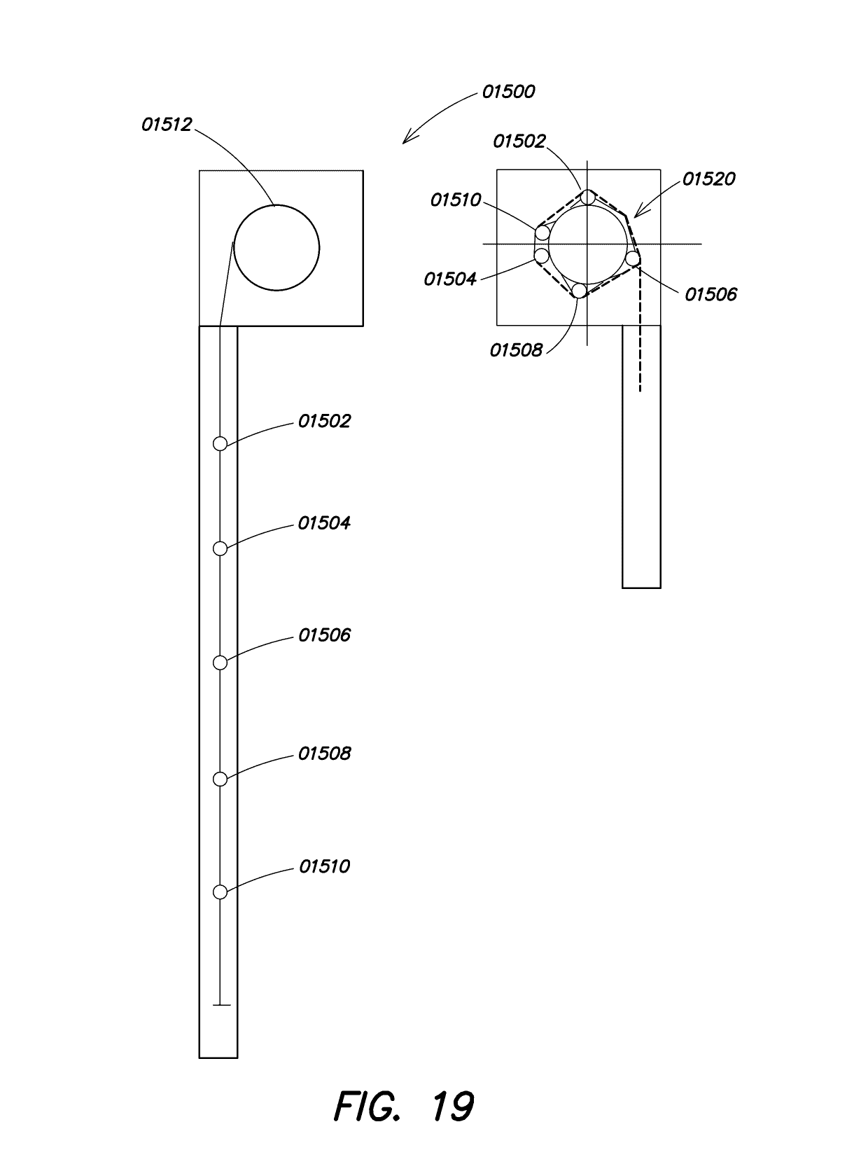

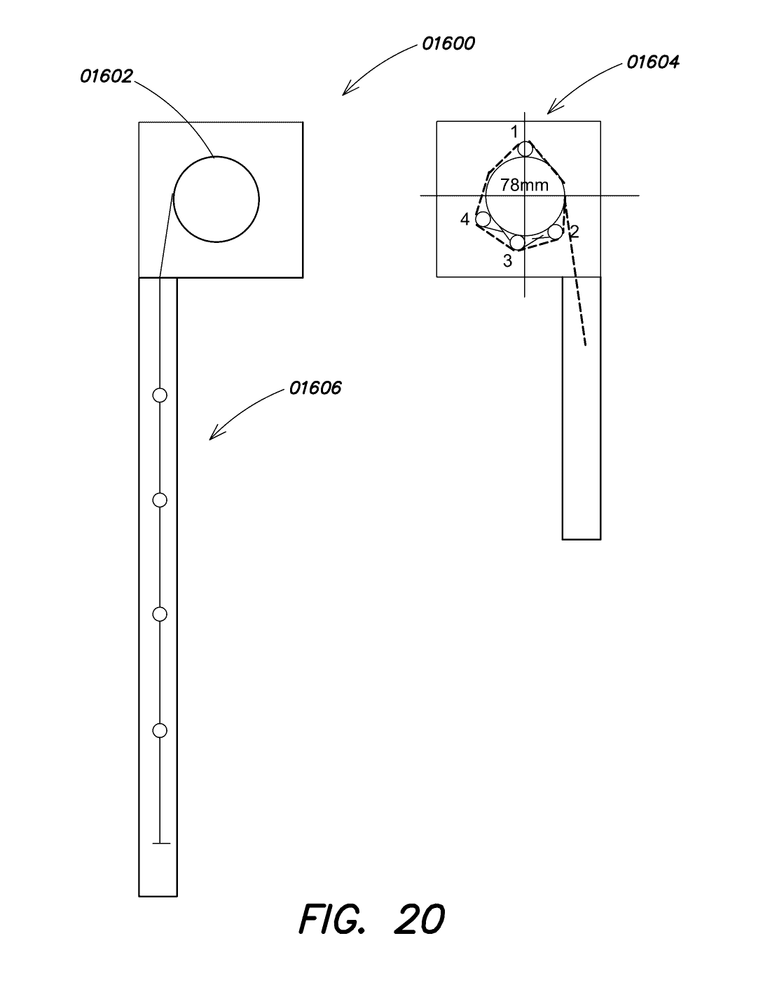

In one example implementation, a 70 mm diameter roll tube is used for curtain assemblies having total height between 126 and 144″. With the curtain fully extended from the roll tube the spacing of the fabric stiffeners (e.g., ½″ rod) can be as follows: 01340A —20″, 01340B—25¾″, 01340C—25⅝″, 01340D—25⅝″, and 01340E—25⅝″. FIG. 18 illustrates another embodiment of a curtain assembly 01400 with four fabric stiffeners 01402-01408 with the curtain extended and the fabric stiffeners with the curtain wound around roll tube 01410. The curtain is constructed and arranged with fabric stiffeners having spacing that prevents overlap on the roll tube. In one example, 01420A—36″, 01420B—26⅞″, 01420C—26⅞″, 01420D —30″. The curtain assembly can include a weighted bottom bar having a variable spacing. In one example, the variable spacing for the hem bar can be customized to an installation location. In the example embodiment shown in FIG. 014, the roll tube can be constructed with a 85 mm diameter, the fabric stiffeners can be constructed with 0.81″ diameter, and the curtain thickness can be up to 0.7 mm. The assembly shown in FIG. 014 can be constructed to accommodate many widths. In one example, assembly 01400 can be used up to 18′ widths and still operate in high wind environments. FIG. 19 is an example embodiment of a curtain assembly 01500 having five fabric stiffeners (e.g., 01502-01510). The positions of the respective stiffeners are shown at 01520. In one example, the roll tuber 01512 is a 70 mm diameter roll tube with stiffeners of ½″ diameter. FIG. 20 illustrates another embodiment, with a 78 mm diameter roll tube 01602 and 0.81″ fabric stiffeners and respective spacing of the stiffeners when wound 01604 and unwound 01606 from the roll tube.

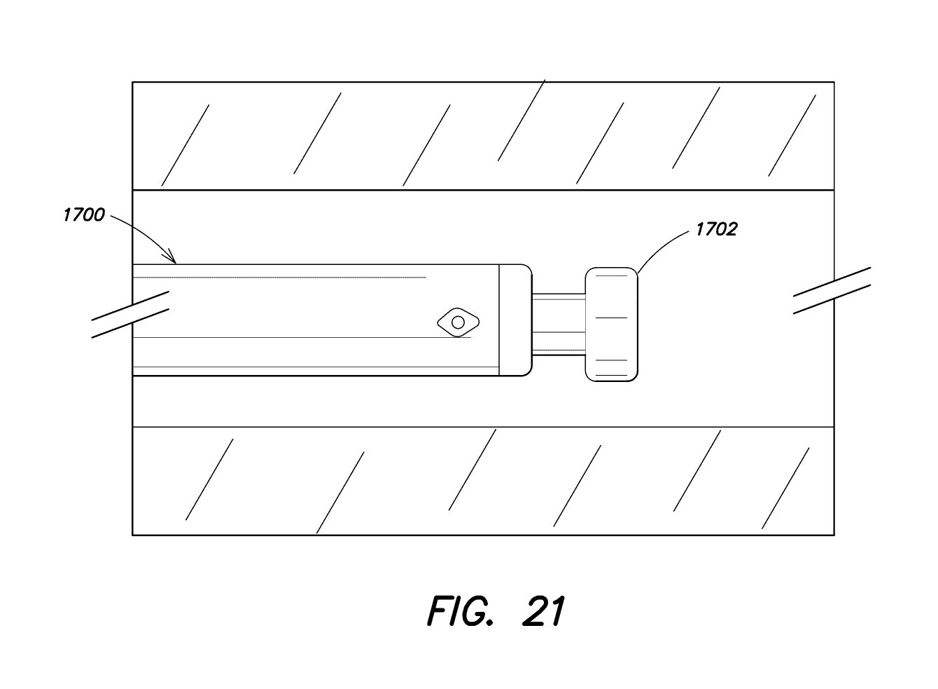

FIG. 21 illustrates an example fabric stiffener 1700 and end lock pin 1702. In one embodiment the fabric stiffener can be constructed of a hollow aluminum tube and the locking pin of a vinyl or plastic material. The plastic or vinyl material can be constructed so that when engaging a ramp structure of a track guide the locking pin slides easily against the ramp structure.

FIG. 1D illustrates an example embodiment of a curtain assembly. Curtain assembly 100 can be configured to operate over sloped surfaces, including windows, and/or other openings. Curtain assembly 100 includes mounting brackets 102 for installing a roll tube 104 having a curtain 108 over, for example, a window. In some examples, the curtain 108 is made of fabric. In other examples, the fabric curtain can be made of natural fibers, and in others can be constructed of artificial fibers. In some other examples, the curtain can be constructed of a blend of natural and artificial fibers. According to one embodiment, the fabric curtain is a flat sheet of fabric wound around the roll tube 104. Rotation of roll tube 104 causes curtain 108 to transition between an open (recessed) and a closed (extended) position. The rotation of roll tube 104 can be controlled via a drawn string (not shown), or in some embodiments curtain assembly 100 can include motors for rotating roll tube 104 (not shown). The curtain 108 may include fabric stiffeners 106 to provide rigidity. Fabric stiffeners 106 can be constructed of various materials, including metal bands fixed to one or more sides of the curtain. Co-pending application Ser. No. 12/911,807, entitled ARCHITECTURAL APPARATUS AND METHOD, filed on Oct. 26, 2010, incorporated by reference herein by reference in its entirety, describes examples of banding constructed about fabric curtains that provide rigidity and support for the curtains of various curtain assemblies. The banding based stiffeners can be modified to include locking portions (e.g., 128A-C and 124A-C) at their respective ends, and the locking portions can be mate with ramp structures (e.g., 126 and 122) in the track guides to provide lateral stability. For example, the locking portions provide lateral stability even in high winds.

The curtain 108 is constructed to ride within guide tracks 114 during operation. Guide tracks 114 can include track inserts (not shown in FIG. 1) configured to mate with curtain 108. In other embodiments, the guide track do not include track guides, but rely on ramp structures and locking portions on the fabric stiffeners 106 to hold the curtain in place and, for example, taught during operation.

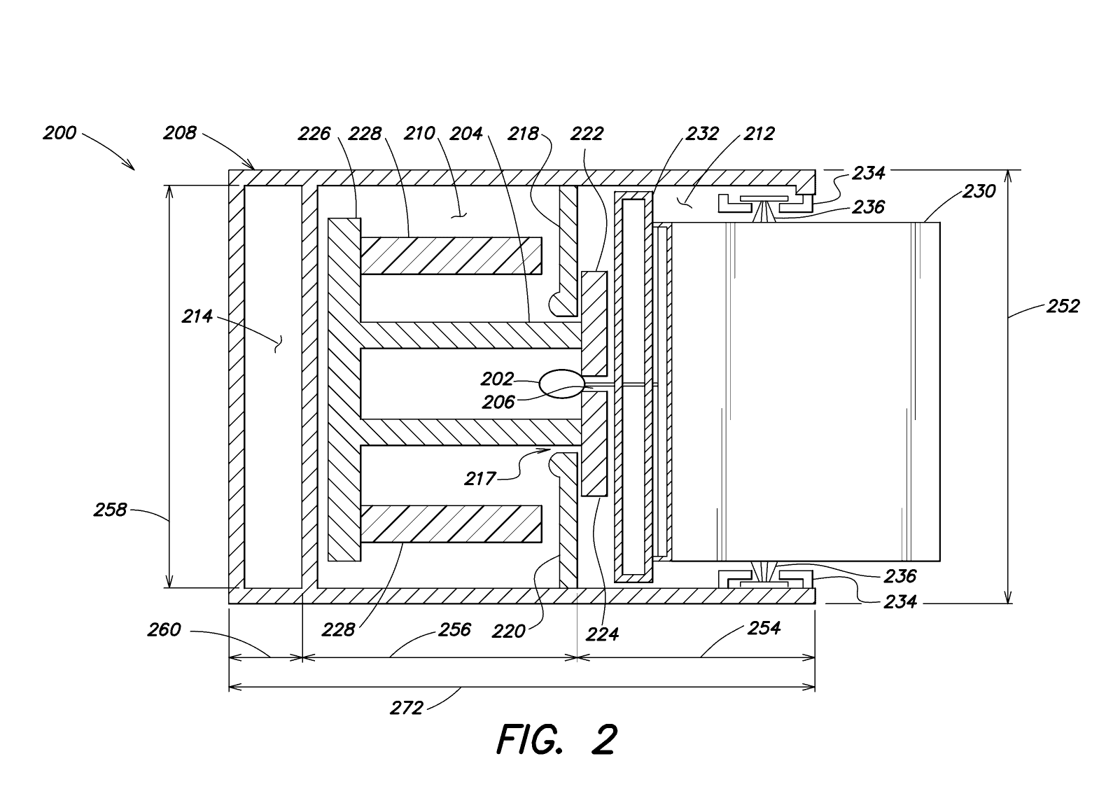

In some embodiments, curtain 108 is constructed with zipper edges 110. Zipper edges 110 resemble one half of a conventional zipper structure. Zipper edge 110 includes teeth which can be constructed of various materials including metal or plastic. The teeth of zipper edge 110 ride within a channel defined by the track insert. Referring to FIG. 2, track assembly 200 illustrates an example of teeth 202 of a zipper edge, configured to mate with a track insert 204. Track insert 204 defines a channel 206 in which a portion of the curtain or a portion of a zipper edge 110 may move freely during transitions between opened and closed positions of a curtain assembly. The teeth 204 and the channel 206 are constructed and arranged to prevent the curtain from coming free of the track insert 204. The track assembly shown in FIG. 2 illustrates a cross section view of one of the track guides shown in FIG. 1 at 114. Returning to FIG. 1D, zipper edges 110 can be constructed to provide rigidity in the curtain 108. Alternatively, fabric stiffeners and locking pins (see FIGS. 1A-C) can be constructed to provide rigidity in curtain 108. In some embodiments, as curtain 108 deflects from a plane of operation defined between the track guides 114, opposing pressure will be exerted on the curtain 108 by virtue of the teeth 202 disposed in the track insert 204 on either side of the curtain 108.

According to one embodiment, curtain 108 is attached to a bottom rail 112. Bottom rail 112 is constructed and arranged to assist in the operation of the curtain assembly between an open position and a closed position. In some embodiments, bottom rail 112 can include weights at 120. The weights are configured to assist in unwinding the curtain 108 from the roll tube 104 into a closed position and to provide resistance as the curtain 108 is wound around roll tube 104 towards an open position. In some embodiments, the weights at 120 are optional. In horizontal implementations, for example, weights at 120 provide little or no assistance in operation of the curtain assembly. In some embodiments, bottom rail 112 includes wheel assemblies (not shown) at both ends of the bottom rail 112. The wheel assemblies guide the bottom rail 112 within the track guides 114. The wheel assemblies can be constructed to reduce friction during normal operation of the curtain assembly. In other embodiments, the bottom rail can include locking portions at 124C and 128C that moveable engage with ramp structures 126 and 122. In some embodiments, bottom rail 112 can define a tubular structure in which weights can be placed. In other embodiments, bottom rail 112 defines an elliptical structure to which curtain 108 can be attached. In another example, curtain 108 can form a pocket at the base of the curtain in which bottom rail 112 can be located.

Optionally, bottom rail 112 can be attached to tension cables 116 and tension boxes 118. Tension cables 116 and tension boxes 118 can be configured in conjunction with weights 120 to assist in operation of the curtain 108 between open and closed positions. In some embodiments, tension cables 116 and 118 can be used instead of weights at 120. The tension boxes 118 exert a force on the bottom rail 112 pulling the bottom rail 112 towards the tension boxes through tension cables 116.

Mounting brackets 102 at the end of the roll tube 104 mate with mounting structures (not shown) that can be installed on a given surface. In one example, mounting brackets 102 are positioned for installation at the top of a window. In some settings, mounting brackets 102 can be positioned within a frame of a window. Track guides 114 can be installed below and/or adjacent to the mounting brackets 102. Track guides 114 can be installed on the side edges of a window frame. In some embodiments, track guides can be installed adjacent to a window frame so that the curtain assembly can cover the window and the frame.

Returning to FIG. 2, shown is an example track assembly which includes a track guide 208. Track guide 208 defines a first channel 210 constructed and arranged to house a portion of track insert 204. For embodiments that do not include the track insert ramp structures (e.g., 122 and 126) can be disposed in the first channel 210 that extend the length of the track guide. Locking pins on fabric stiffeners moveably engage the ramp structures (e.g., 122 and 126) to provide lateral stability to the curtain. Each of the ramp structures can include a curved portion at an upper region that facilitates the locking pins being wound on and off of a roll tube, as shown in FIG. 1B.

In embodiments with a track insert, the track insert 204 is moveably coupled to track guide 208. A portion of track insert 204 is positioned within the first channel 210 and at least a portion of a yoke of the track insert 204 is positioned within a second channel 217 defined by a first 218 and second flange 220 of the track guide 208. Track insert 204 includes a first 222 and second cap 224 portions that are constructed to hold the track insert 204 in the first channel 210 and second channel 217. The first 222 and second 224 cap portions operate in conjunction with a base portion 226 of the track insert 204 to hold the track insert in place. In some embodiments, the track insert 204 can include compressible portions 228.

In some examples, the compressible portions 228 can be constructed of felt, sponge material, rubber, bristles or other compressible material. The compressible portions 228 can be configured to permit side to side movement of track insert 204 in the second channel 217. According to some embodiments, the capability of side to side movement assists in the operation of the curtain assembly. During periods of increased pressure on the curtain (e.g., 108 in FIG. 1D) compressible portions 228 can be compressed relieving tension in the curtain and insuring the curtain does not become bound in place during operation.

When a curtain is moved between the open and the closed positions or anywhere in between the portion of the curtain or the portion of the zipper edge will move freely in channel 206. Additionally, a bottom rail 230 of the curtain assembly is also configured to move freely within a third channel 212 defined by the track guide 208. A wheel assembly 232 assists in free movement of the bottom rail 230 in the third channel 212. The wheel assembly 232 may comprise a single wheel and an axis connecting the wheel to the bottom rail 230. In other embodiments, different configurations can be employed including, for example, ball bearing structures, or other structures that are configured to reduce friction between the bottom rail 230 and the track guide 208 as the bottom rail 230 and/or curtain move within the third channel 212. According to one embodiment, the third channel 212 can include housing structures 234. In one example, housing structures 234 are constructed and arranged to include bristles at 236 which also can be configured to maintain the position of bottom rail 230 within the third channel 212 during operation of a curtain assembly. In one alternative, housing structures 234 can be constructed and arranged with felt strips at 236 instead of bristles. Other compressible materials can also be employed at 236 to guide and control movement of the bottom rail 230 during operation of a curtain assembly. In some implementations housing structures 234 and bristles 236 can be omitted.

According to some embodiments, track guide 208 further defines a fourth channel 214. The fourth channel 214 is constructed and arranged to provide greater structural integrity to track guide. In some embodiments, track guide 208 can be fabricated from aluminum and various structures can be constructed, e.g., fourth channel 214, to provide for a desired strength for track guide 208. In some embodiments, the fourth channel can be omitted. In other embodiments different materials can be used to mold, cast, and/or extrude a track guide and a fourth channel 214 can be included as necessary to establish a desired strength for the track guide 208. In one example, the track guide 208 can be constructed of steel. In another example, the track guide 208 can be constructed of plastic.

The material selected and the dimensions of track assembly 200 can vary depending upon a given installation site. Materials can be selected based on aesthetic as well as based on structural considerations. In one example, the dimensions of the track guide can be 1.44 inches at 252, 0.67 inches at 254, 0.79 inches at 256, 1.255 inches at 258, 1.93 inches at 572, and 0.47 inches at 260. In other embodiments, different dimension can be employed. Further, different material used to construct the track guide 208 can require different dimensions and/or permit smaller installation dimensions.

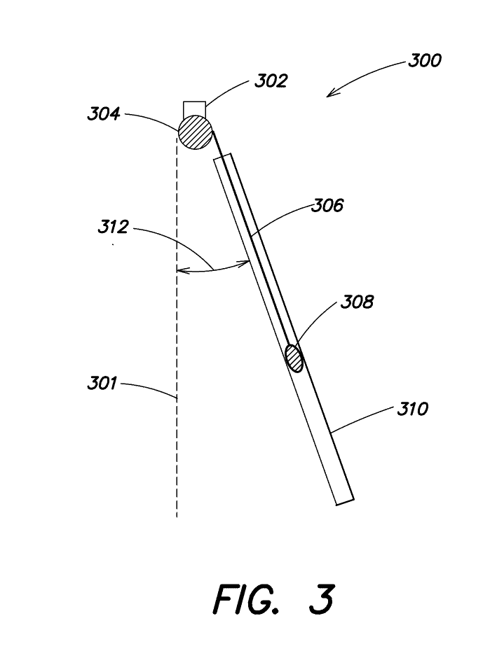

Shown in FIG. 3, is an example curtain assembly 300, illustrated in a side view, installed and operable along a slope. Dashed line 301 illustrates a hypothetical plumb line drawn from the top of the installation position. In some settings, the installation slope shown by angle 312 follows an irregularly shaped structure, for example a slopping wall, window, etc. In some embodiments, the curtain assembly can be installed and be operable in a horizontal position, e.g., where angle 312 is 90 degrees from line 301. The curtain assembly is mounted to the structure to be covered (e.g., window, frame, opening) via mounting brackets at 302. The mounting brackets are coupled to a roll tube 304 around which a curtain 306 is wound. Typically, the curtain assembly is configured for installation in an interior of a building, house or other residential structure. In some embodiments, the curtain 306 can be constructed of a flat panel of cloth and/or fabric. In one example, the curtain comprises a single flat panel wound around roll tube 304. In other examples, the fabric can be woven from artificial and/or natural fibers. Optional curtain stiffeners (not shown) can be employed to maintain the flat shape of the curtain during operation. Further, stiffeners can be required when covering windows, as air flow through open windows can tend to distort the shape and appearance of a fabric and/or cloth curtain.

In other embodiments, tension provided by opposite track guides, e.g., 310, to which the curtain is attached, can maintain the shape and appearance of the curtain 306 during operation and in any fixed position. Further, weight provided by bottom rail 308 can also provide tension within the curtain 306 that maintains the shape and appearance of the curtain 306. The weight of bottom rail 308 can be adjusted based on the tension desired in the curtain 306 and an installation slope at which curtain assembly 300 is installed. Bottom rail 308 and curtain 306 are guided within track guide 310 during operation of the curtain assembly between an open position, where the curtain is wound around roll tube 304 and a closed position where curtain 306 is unwound from roll tube 304 to cover the opening on which curtain assembly 300 is installed.

Curtain 306 is configured to be moveable to occupy any position along track guide 310 based on rotation of roll tube 304. In some embodiments, the rotation of roll tube 304 can be accomplished via a draw string mechanism (not shown) or other motorized structures (not shown) for rotating roll tube 304 in both directions. In other embodiments, curtain 304 can be configured to be in an equilibrium state when not moving, but configured to tend towards a direction of motion when operated, for example, by hand. In some embodiments, springs can be installed in roll 304 to balance the weight applied by bottom rail 308, so that curtain 306 can be easily manipulated by hand.

According to another aspect, a retractable curtain assembly is provided for installation in openings having angled sides, including angled top, bottom, and side edges. Conventional curtains are installed about or abutting windows to cover rectangular openings. Traditionally, windows or other exterior openings are configured with squared or nearly squared edges which present rectangular or squared spaces. Squared and rectangle openings can be covered during the operation of conventional curtains. Operating curtain assemblies within and/or over irregularly shaped openings presents difficulties that some conventional curtains cannot overcome. According to one embodiment, a retractable curtain assembly is configured to provide complete coverage of an opening as the dimensions of the opening change. In one particular embodiment, the curtain assembly is configured to cover a trapezoidal window. According to another example, a variable length bottom rail can be configured to expand and contract during the transition between an open and closed position of a curtain to insure proper coverage of the trapezoidal window. In another embodiment, the variable length bottom rail is configured to ride within a track guide. In one example, the variable length bottom rail is connected to a wheel assembly that is constructed and arranged to fit within a channel defined in the track guide. During transitions between an open and closed position, the wheel assembly is configured to exert pressure on the variable length bottom rail, causing the variable length bottom rail to expand or contact lengthwise to fit within the opening defined by the track guide.

According to one aspect, a curtain assembly is provided. The curtain assembly comprises a curtain selectably moveable between an open position and a closed position connected to a variable length bottom rail, a track guide that defines a side of a plane of operation of the curtain as it moves between the open position and the closed position, the variable length bottom rail constructed and arranged to vary in length as a distance between a pair of track guides varies, and a wheel assembly moveably coupled to the track guide, wherein the variable length bottom rail is coupled to the wheel assembly, and the wheel assembly is configured to exert force on the variable length bottom rail causing the variable length bottom rail to expand and contract in response to changing distances between the pair of track guides during transition between the open and the closed position. According to one embodiment, the curtain assembly further comprises at least one stiffener elements constructed and arranged to maintain a shape of the curtain within the plane of operation. According to one embodiment, the curtain is a fabric curtain. According to one embodiment, the plane of operation is defined on a slope. According to one embodiment, the slope is greater than 10 degrees. According to one embodiment, the slope is greater than 20 degrees. According to one embodiment, the slope is greater than 30 degrees. According to one embodiment, the slope is greater than 40 degrees.

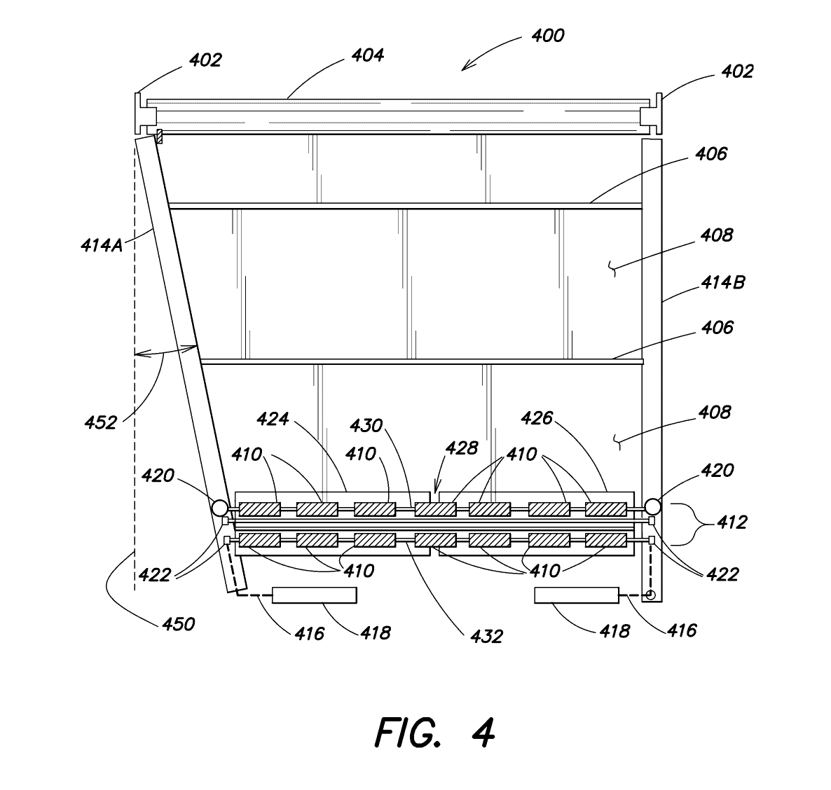

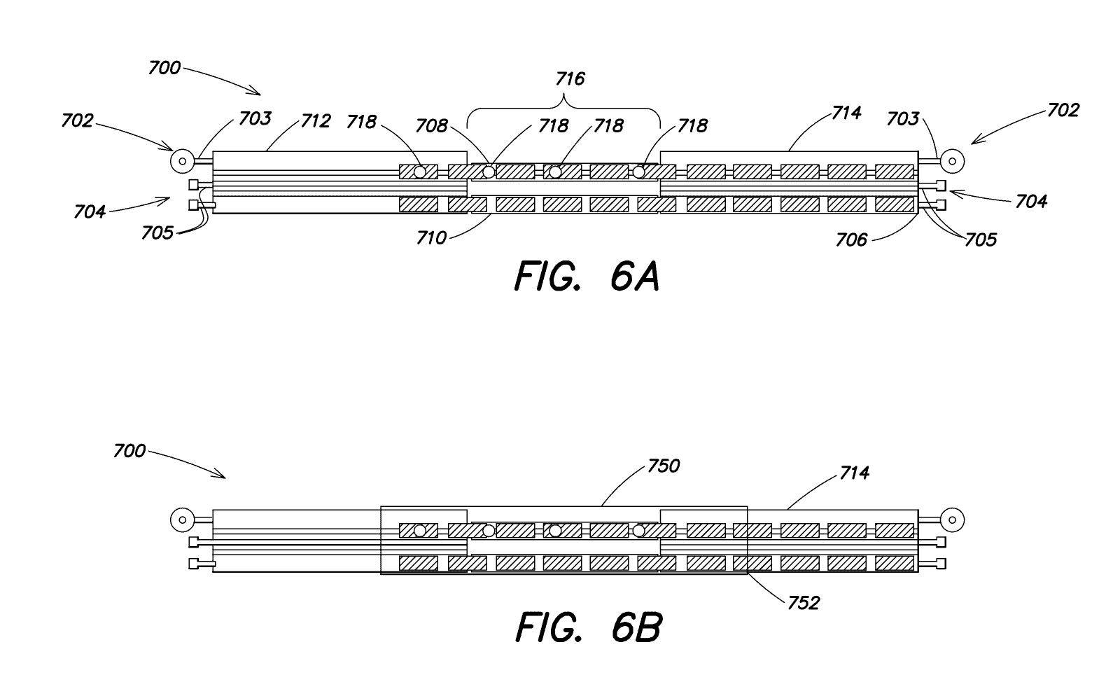

FIG. 4 illustrates an example embodiment of a curtain assembly 400 incorporating some aspects of the present disclosure. Curtain assembly 400 is constructed and arranged to cover irregularly shaped openings, for example windows, frames, doors, etc. The irregular shapes can include trapezoids, triangles, partial ellipses, etc. According to some embodiments, the curtain assembly can be installed over such irregular openings even where the opening is constructed on a sloped surface, window, and/or other opening, requiring the curtain assembly to operate on a sloped plane, as shown in FIG. 6.

The curtain assembly 400 includes mounting brackets 402 for installing a roll tube 404 having a curtain 408 that covers, for example, a window. In some examples, the curtain 408 is made of fabric. In other examples, the fabric curtain can be made of natural fibers, and in others can be constructed of artificial fibers. In some other examples, the curtain can be constructed of a blend of natural and artificial fibers. According to one embodiment, the fabric curtain 408 is a flat sheet of fabric wound around the roll tube 404. Rotation of roll tube 404 causes curtain 408 to transition between an open (recessed) and a closed (extended) position. The rotation of roll tube 404 can be controlled via a drawn string (not shown) or in some embodiments curtain assembly 400 can include motors for rotating roll tube 404 (not shown). The curtain 408 may include fabric stiffeners 406 to provide rigidity. Fabric stiffeners 406 can be constructed of various materials, including metal bands fixed to one or more sides of the curtain. In some embodiments, the fabric stiffeners 406 can be omitted.

According to one embodiment, curtain 408 is attached to a bottom rail 412. Bottom rail 412 is constructed and arranged to assist in the operation of the curtain assembly 400 between an open position and a closed position. In some embodiments, bottom rail 412 includes a wheel assembly 420 and stabilizer pins 422 at both ends of the bottom rail 412. The wheel assemblies 420 guide the bottom rail 412 within the track guides 414. The stabilizer pins 422 ride within the track guides 414A-B and insure the bottom rail 412 does not rotate during operation. The wheel assemblies 420 can be constructed to reduce friction during normal operation of the curtain assembly. Further, the wheel assemblies 420 mate with an internal channel constructed within the track guides 414A-B. As the wheel assemblies 420 travel in the channels constructed in the track guides 414, the change in distance between the wheel assemblies 420 results in an operational force applied to the bottom rail 412. The operational force applied to the bottom rail 412 causes the bottom rail 412 to change in length as the bottom rail is moved along the track guide 414. The change in length required depends upon the structure in which the curtain assembly is installed. Dashed line 450 illustrates a hypothetical plumb line drawn from mounting bracket 402. The angle of the slope 452 can vary depending upon the installation site. Further, track guides 414A-B are illustrated with only one track guide 414A showing a sloped installation. In other embodiments, both track guides can be installed at angles relative to respective plumb lines. Further curtain assembly 400 can be configured to operate over and/or within a variety of structures having differently sloping sides, top, and/or bottom edges. In some other embodiments, not only may structure have irregularly shaped edges, top, and/or bottom sides, requiring the track guides to be sloped, but the plane of operation of the curtain itself may also be sloped. An example of a curtain assembly showing a sloped plane of operation is illustrated in FIG. 6.

Returning to FIG. 4, in some embodiments, the bottom rail 412 is constructed of a first portion 424 and a second portion 426, which move laterally relative to each other as the bottom rail is operated up and down within track guide 414. The opening shown at 428 expands and contracts based on the movement of bottom rail 412. Not shown in FIG. 4 is a sleeve that surrounds the first 424 and second portion 426 of the bottom rail to cover the opening 428 during operation of the curtain assembly 400. The sleeve is constructed to provide a surface for the curtain 408 during the telescoping of bottom rail 412.

In some embodiments, the bottom rail 412 can define a tubular structure in which weights can be placed. In other embodiments, the bottom rail 412 defines an elliptical structure to which curtain 408 can be attached. In another example, curtain 408 can form a pocket at the base of the curtain in which the bottom rail 412 can be located. In one embodiment, stabilizer bars 430 and 432 can be constructed within the bottom rail 412. In one example, either one or both stabilizer bars 430-432 can be fixed to one side of the bottom rail 412. The first portion 424 and the second portion 426 of the bottom rail 412 are configured to slide over stabilizer bars 430-432 as the bottom rail 412 expands and contracts in length during operation of the curtain assembly 400.

Optionally, bottom rail 412 can be attached to tension cables 416 and tension boxes 418 to assist in moving the curtain assembly 400 between the open and closed positions. The tension cables 416 and tension boxes 418 can be configured in conjunction with weights at 410 to assist in operation of the curtain 408 between the open and closed positions. Tension boxes 418 exert a force on bottom rail 412 through tension cables 416 towards the closed position of curtain 408.

In some embodiments, the bottom rail 412 can include weights at 410. The weights 410 are configured to assist in unwinding the curtain 408 from the roll tube 404 into a closed position and to provide resistance as the curtain 408 is wound around roll tube 404 towards an open position. The weights 410 can be attached to stabilizer bars 430-432. In some alternatives, the weights 410 can be disposed within the bottom rail 412. In some embodiments, the weights at 410 are optional. In horizontal implementations, for example, weights at 410 provide little or no assistance in operation of the curtain assembly. In some embodiments, tension cables 416 and 418 can be used instead of weights at 410.

Mounting brackets 402 at the end of the roll tube 404 mate with mounting structures (not shown) that can be installed on a given surface. In one example, mounting brackets 402 are positioned for installation at the top of a window. In some settings, mounting brackets 402 can be positioned within a frame of a window. The track guides 414A-B can be installed below and/or adjacent to the mounting brackets 402. The track guides 414A-B can be installed on the side edges of a window frame and configured to follow non-traditional shapes. In some examples, the covered structure may define a trapezoid, a triangle, etc. In some embodiments, the track guides can be installed adjacent to a window frame so that the curtain assembly can cover both the window and the frame.

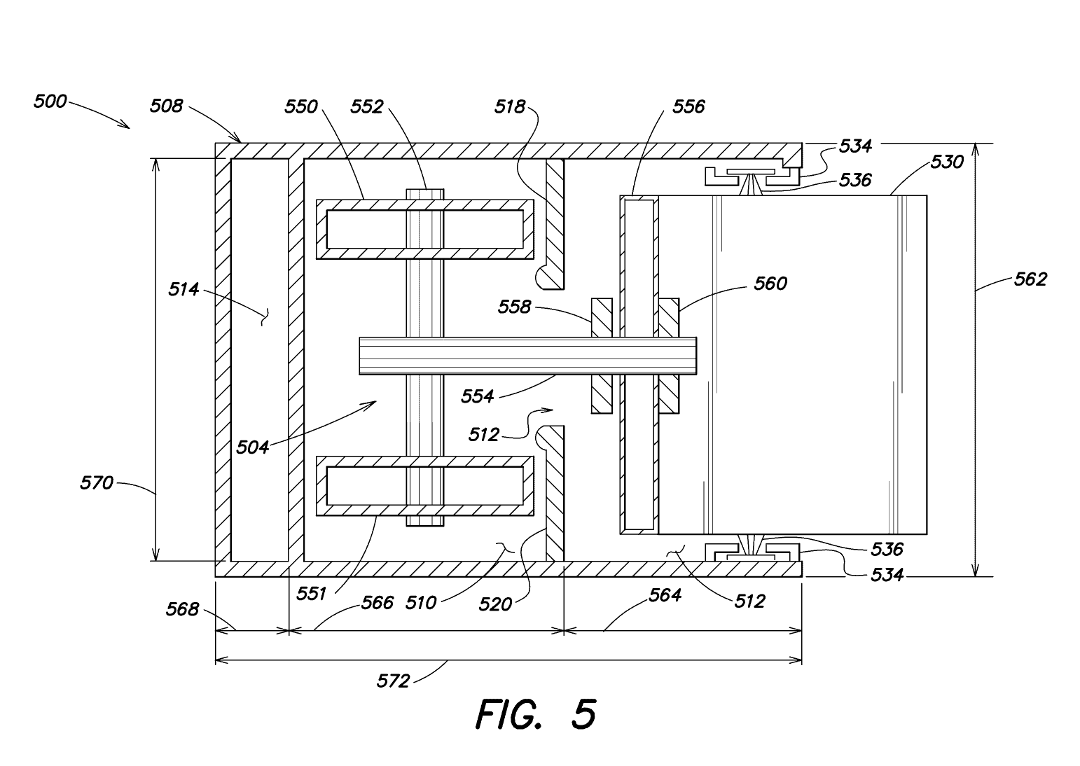

Shown in FIG. 5, is an example track assembly 500. Track assembly 500 is a cross section view of a track guide 508 and other structures which illustrate a portion of a curtain assembly including a curtain attached to roll tube and a bottom rail. The curtain assembly is configured to operate between an open and closed position by rotation of the roll tube, during which operation a bottom rail 530 rides along the track guide 508, with the bottom rail 530 expanding and contracting in length as necessary. According to some embodiments, the track guide 508 is installed at a slope relative to a second track guide (not shown). The slope of track guide 508 results in a variable distance between the track guide 508 and the second track guide requiring the bottom rail 530 to expand and/or contract as the bottom rail 530 travels the length of the track guide 508 and the second track guide.

The track guide 508 includes a first channel 510 constructed and arranged to house a wheel assembly 504 or in another embodiment the first channel can include ramp structures and locking pins. In one example, the wheel assembly 504 is moveably coupled to the track guide 508 within the first channel 510. During operation of the curtain assembly (e.g., the raising and lowering of a curtain and attached bottom rail) the wheel assembly 504 rides within the first channel 510 as the bottom rail moves with the curtain. According to one embodiment, the wheel assembly 504 is constructed of paired wheels 550 and 551 connected by a first rod 552 about which the wheels 550-551 rotate. The first rod 552 is connected to a second rod 554 which is connected to one end of the bottom rail 530 at a bottom rail end 556. The connection between the second rod 554 and the bottom rail end 556 can include welds or additional structures to secure the second rod 554 to the bottom rail end 556. In one embodiment, second rod 554 can be configured to extend through a hole in the bottom rail end 556, and locking structures 558 and 560 can be configured to hold the second rod 554 in place against bottom rail end 556. In one example, second rod 554 can include threaded portions and locking structures 558 and 560 can be configured to mate with the threaded portions of the second rod 554. In one alternative, the second rod 554 can be attached directly to the bottom rail 530, and the locking structures 558-560 can be omitted. In one example, the second rod 554 can be welded directly to bottom rail end 556. In another alternative, the second rod 554 can include a threaded portion to which the bottom rail end 556 mates.

In one example, the second rod 554 extends through a second channel 517 defined by the track guide 508 between a first 518 and second flange 520 of the track guide 508. The second rod 554 rides within the second channel as the bottom rail 530 travels in the track guide 508. The wheels 550 and 551 of the wheel assembly 504 ride against the first 518 and second flange 520, during operation of the bottom rail 530. As the distance between the track guide 508 and a second track guide increases a force is applied to the bottom rail 530 through the wheel assembly 504 and a respective wheel assembly housed within the second track guide. The force applied to the bottom rail 530 causes its expansion and/or contraction. For example, as shown above with respect to FIG. 4, the bottom rail 412 expands and contracts in length as the curtain assembly 400 is operated between the closed and open position—causing the distance between wheel assemblies at 420 to decrease and increase respectively.

When a curtain is moved between the open and the closed positions or anywhere in between the bottom rail 530 is also configured to move freely within a third channel 512 defined by the track guide 508. According to one embodiment, the third channel 512 can include housing structures 534. In one example, housing structures 534 are constructed and arranged to include bristles at 536 which can be configured to maintain the position of bottom rail 530 within the third channel 512 during operation of a curtain assembly. In one alternative, housing structures 534 can be constructed and arranged with felt strips at 536 instead of bristles. Other compressible materials can also be employed at 536 to guide and control movement of the bottom rail 530 during operation of a curtain assembly. In some implementations housing structures 534 and bristles 536 can be omitted. In some implementations, the housing structures and compressible material at 536 can be configured to dampen sound during operation of a curtain assembly.

According to some embodiments, the track guide 508 further defines a fourth channel 514. The fourth channel 514 is constructed and arranged to provide greater structural integrity to the track guide. In some embodiments, the track guide 508 can be fabricated from aluminum and various structures can be constructed, e.g., fourth channel 514, to provide for a desired strength for track guide 508. In some embodiments, the fourth channel can be omitted. In other embodiments different materials can be used to mold, cast, and/or extrude a track guide and a fourth channel 514 can be included as necessary to establish a desired strength for the track guide 508. In one example, the track guide 508 can be constructed of steel and/or stainless steel. In another example, the track guide 508 can be constructed of plastic.

The material selected and the dimensions of track assembly 500 can vary depending upon a given installation site. Materials can be selected based on aesthetic as well as based on structural considerations. In one example, the dimensions of the track guide can be 1.44 inches at 562, 0.67 inches at 564, 0.79 inches at 566, 1.255 inches at 568, 1.93 inches at 572, and 0.47 inches at 570. In other embodiments, different dimension can be employed. Further, different material used to construct the track guide 508 can require different dimensions and/or permit smaller installation dimensions.

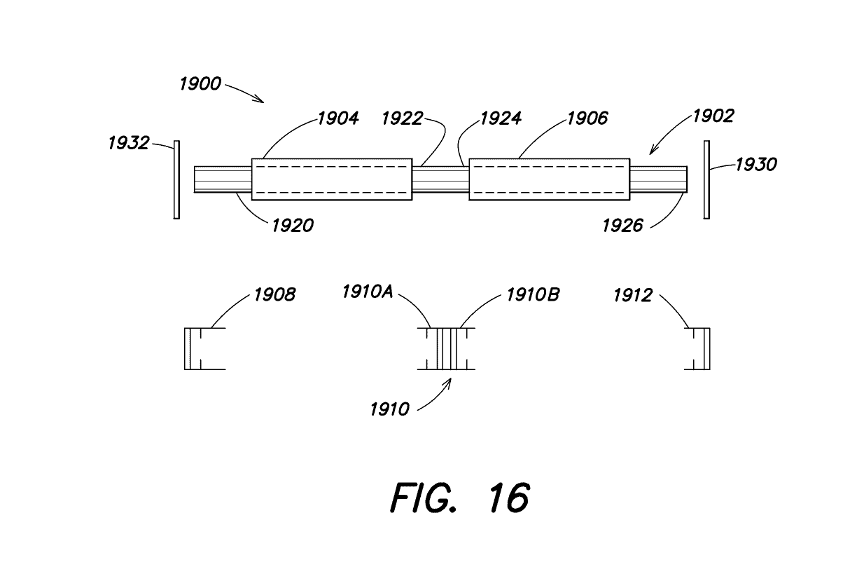

Shown in FIG. 16, is embodiment of a multi-curtain curtain assembly 1900. Assembly 1900 includes a multi-curtain roll tube 1902. Multiple curtains can be wound on the roll tube 1902 (e.g., at curtain roll portions 1904 and 1906) with each curtain having its own track guides (e.g., 1908 and 1910 and 1910 and 1912). In an interior portion of the curtain assembly, two single track guides can be used each opening towards one of the adjacent curtains (e.g., at positions 1910A and 1910B). In one embodiment a dual track guide can be used. Assembly 1900 illustrates an embodiment of a dual track guide 1910 having track portions for each curtain at 1910A and 1910B. The dual track guide can be constructed with dual structures facing the adjacent curtains (e.g., 1910A and 1910B) so the single dual track guide can assist in the movement of multiple curtains. For example, the structures described above with respect to any of FIGS. 1A-1D, and FIG. 2, are repeated with one set of structures opening towards one of a pair of adjacent curtains and the other set of structures opening towards the opposite direction. Each curtain can have associated offset portions constructed in roll tube 1902. In one embodiment, adjacent to each curtain are offset portions 1920, 1922, 1924, and 1926. The offset portions can be constructed and arranged to have a smaller diameter relative to curtain roll portions 1904 and 1906 at which curtains may be attached. The smaller diameter can be configured to accept any additional width associated with, for example, a zipper edge of a curtain connected at 1904 and/or 1906 or locking pins on the ends of fabric stiffeners. Illustrated at 1930 and 1932 are portions of a head box which can enclose assembly 1900. In some examples, assembly 1900 can be connected at 1930 and 1932 to a head box. The connections at 1930-32 enable the roll tube to be rotated, which results in operation of any connected curtain between open and closed positions.

According to another aspect, curtain assemblies can be constructed and arranged with overlapping curtains and corresponding structures. According to one embodiment, a multiple roll tube head box can be employed to cover multiple roll tubes which house any number of curtains configured for a given area. FIGS. 1D and 2 illustrate examples of the components of a single curtain curtain assembly. In some embodiments, multiple curtains can be installed in the same area by layering two single curtain assemblies over the same area. In some implementations, multiple tracks (e.g., as shown in FIG. 2 for a single curtain) can be installed over each other to provide for tracked operation of multiple curtains. Some arrangements of multiple curtain assemblies can include offset roll tubes for housing the multiple curtains.

Shown in FIG. 10A is an example embodiment of a curtain assembly 1000 having multiple curtains 1010, 1020, and offset roll tubes 1030 and 1040. Shown in FIG. 10A is a cross section of the head box 1002. The tracks and track inserts have been excluded for purposes of clarity. Each curtain has a zippered edge 1012, 1014 that is configured to ride within a track and track insert installed at the edges of the curtain assembly. The tracks can be separate or integrated to provide a single structure with multiple track spaces configured to hold multiple curtains in place during operation. Curtains 1010 and 1020 can be configured to operate together. In some embodiments, curtains 1010, 1020 can be configured to move between open and closed positions together. In some further embodiments, the bottom rails of each curtain 1050, 1060 can also be configured to seal against any opening covered by the curtain assembly (not shown). In FIG. 10B, illustrated in cross section is an example of a curtain assembly installed in a recessed window frame. The frame 1099 can be configured with a compressible portion 1098 to improve a seal between curtains 1080, 1090, their respective bottom rails 1093, 1094 and the recessed window frame.

Use of overlapping curtains in various curtain assemblies can achieve significant improvements in sound reduction and energy efficiency in terms of insulating power. Upon mating with the recessed frame at 1098 and air pocket between curtains 1080 and 1090 assists in reducing noise and provides a greater capacity than either curtain alone in preventing changes in energy through the covered area. In some implementations, the air pocket between curtains 1080, 1090 increases the curtain assembly's R value (a measure of thermal resistance conventionally used in construction). The improvement in thermal resistance is realized even during movement of the curtains between open and closed positions and in various fixed positions between open and closed. In addition to thermal resistance improvement, noise reduction capability is also improved in various embodiments.

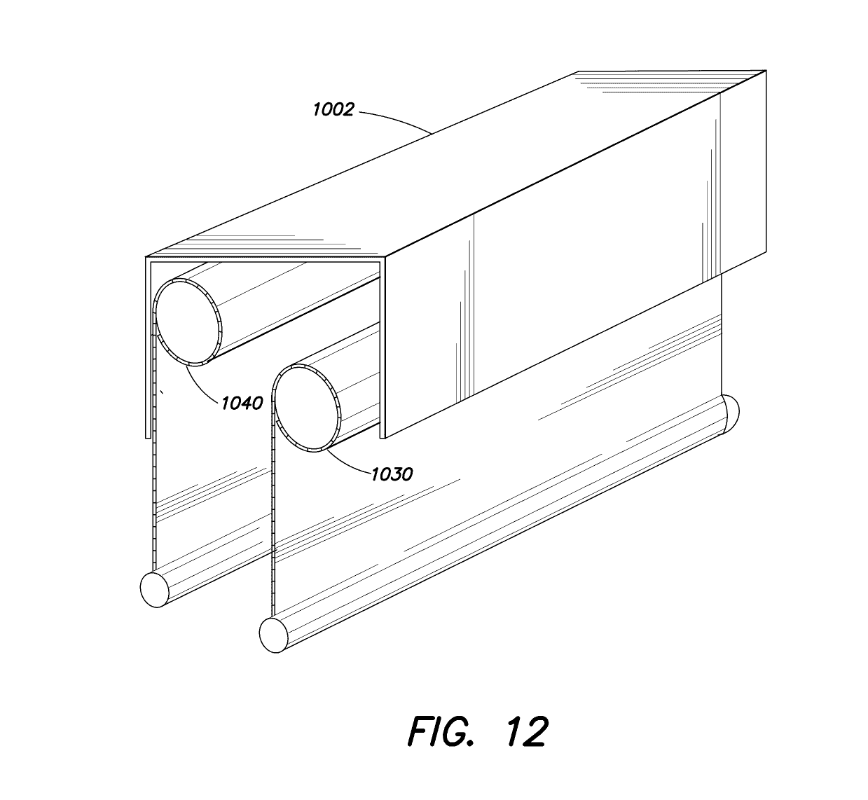

Shown in FIG. 12 is another example implementation of a curtain assembly having multiple curtains. FIG. 12 illustrates an alternate configuration of curtain assembly 1000, with offset roll tubes 1030 and 1040 having different positions within head box 1002. Different configurations of the offset roll tubes can be employed in conjunction with motorized operation of the roll tube—different configurations can be employed, for example, to provide space within head box 1002 for the installation of motor components.

The spacing of the fabric stiffeners on each curtain can also be tailored to ensure that the width of the wound curtains and respective stiffeners do not interfere with each other's operation.

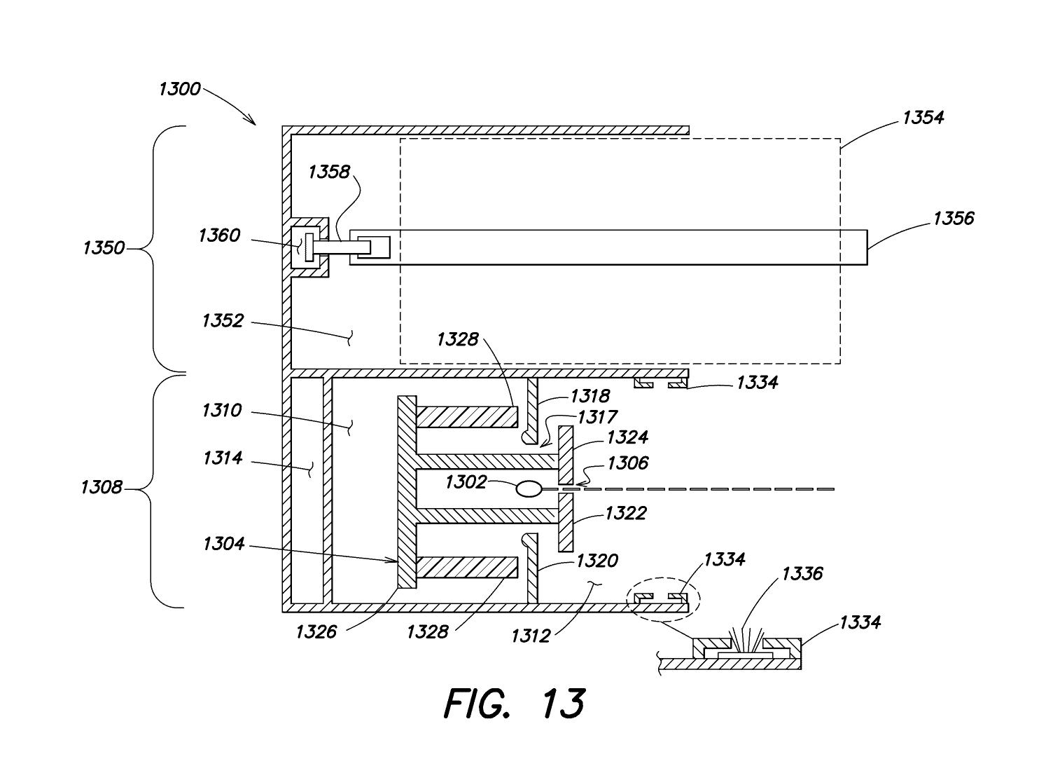

FIG. 13 illustrates one embodiment of a track assembly 1300 including an integrated guide track configured for operation of a multiple curtain assembly, wherein at least one curtain is constructed and arranged of cellular fabric and at least one curtain is constructed and arranged of a flat fabric sheet. In other embodiments, either track 1350 or 1308 can be constructed with a track as shown in FIGS. 1A-1C. In FIG. 13, shown is an example track assembly for multiple curtains which includes a track guide portion 1308. Track guide portion 1308 defines a first channel 1310 constructed and arranged to house a portion of track insert 1304. Track insert 1304 is moveably coupled to track guide 1308. A portion of track insert 1304 is positioned within the first channel 1310 and at least a portion of a yoke of the track insert 1304 is positioned within a second channel 1317 defined by a first 1318 and second flange 1320 of the track guide 1308. Track insert 1304 includes a first 1322 and second cap 1324 portion that are constructed to hold the track insert 1304 in the first channel 1310 and second channel 1317. The first 1322 and second 1324 cap portions operate in conjunction with a base portion 1326 of the track insert 1304 to hold the track insert in place. In some embodiments, the track insert 1304 can include compressible portions 1328. Compressible portions 1328 can be constructed and arranged of a compressible sponge material. In some examples, the material can be selected to increase noise reduction properties of a curtain assembly.

In some examples, the compressible portions 1328 can be constructed of felt, sponge material, rubber, bristles or other compressible material. The compressible portions 1328 can be configured to permit side to side movement of track insert 1304 in the second channel 1317. According to some embodiments, the capability of side to side movement assists in the operation of the curtain assembly. During periods of increased pressure on a curtain compressible portions 1328 can be compressed relieving tension in the curtain and insuring the curtain does not become bound in place during operation.

When a curtain is moved between the open and the closed positions or anywhere in between the portion of the curtain or the portion of the zipper edge will move freely in channel 1306. Additionally, a bottom rail (not shown) of a curtain assembly can be configured to move freely within a third channel 1312 defined by the track guide 1308. In some examples, a bottom rail can be constructed with a wheel assembly (e.g., 232, FIG. 2) which can assist in free movement of the bottom rail in the third channel 1312. According to one embodiment, the third channel 1312 can include housing structures 1334. In one example, housing structures 1334 are constructed and arranged to include bristles at 1336 which also can be configured to maintain the position of a bottom rail within the third channel 1312 during operation of a curtain assembly. In one alternative, housing structures 1334 can be constructed and arranged with felt strips at 1336 instead of bristles. Other compressible materials can also be employed at 1336 to guide and control movement of the bottom rail during operation of a curtain assembly. In some implementations housing structures 1334 and bristles 1336 can be omitted.

According to some embodiments, track guide 1308 further defines a fourth channel 1314. The fourth channel 1314 is constructed and arranged to provide greater structural integrity to track guide. In some embodiments, track guide 1308 can be fabricated from aluminum and various structures can be constructed, e.g., fourth channel 1314, to provide for a desired strength for track guide 1308. In some embodiments, the fourth channel can be omitted. In other embodiments different materials can be used to mold, cast, and/or extrude a track guide and a fourth channel 1314 can be included as necessary to establish a desired strength for the track guide 1308. In one example, the track guide 1308 can be constructed of steel. In another example, the track guide 1308 can be constructed of plastic.

Track assembly 1300 mates with teeth 1302 of a zipper edge, in particular, teeth 1302 are configured to mate with a track insert 1304. Track insert 1304 defines a channel 1306 in which a portion of the curtain or a portion of a zipper edge and teeth 1302 may move freely during transitions between opened and closed positions of a curtain. The teeth 1302 and the channel 1306 are constructed and arranged to prevent the curtain from coming free of the track insert 1304. The material selected and the dimensions of track assembly 1300 can vary depending upon a given installation site. Materials can be selected based on aesthetic as well as based on structural considerations.

FIG. 13 is an example track assembly for multiple curtains which includes a second track guide portion 1350. Portion 1350 defines a channel 1352 configured to house a cellular fabric curtain. Cellular fabric curtain 1353 includes a plurality of stiffener inserts 1356. The stiffener inserts are constructed to provide rigidity to the cellular fabric curtain. Stiffener inserts 1356 are connected to guide portions 1358. Guide portions are constructed to mate with guide channel 1360. Guide portions 1358 move freely in channel 1360 during operation of the cellular fabric curtain 1354 between open and closed positions. Shown in FIG. 13 is one track assembly for multiple curtains. A second track assembly mirroring the first is used in conventional installations.

According to another aspect, a curtain assembly is provided. According to one embodiment, the curtain assembly is configured to fit within the space defined in a window box of a conventional interior window. The window box defines the interior portion of the space in which a window is installed. Typically a window is recessed into a wall so as to be flush or near to flush with the exterior surface of a building in which it is installed. In some embodiments, the curtain assembly can include a head box configured to be installed within the recessed portion of the window box frame. In one example, a head box extends horizontally across the width of the window box frame, shown for example. Further the head box can be attached to the top of the frame to support a curtain assembly and curtains. In other embodiments, the head box can be configured to install horizontally above the window box.

The curtain assembly can be constructed and arranged to open and close paired curtains to cover a window. The paired curtains of the curtain assembly can be configured to define an air pocket between the paired curtains that improves the energy characteristics of the curtain assembly. Further in some embodiments, a curtain assembly having paired curtains can be configured specifically for noise reduction. In some paired curtain constructions, the interior facing curtain or front facing curtain can be selected based on aesthetic or design and the exterior facing or rear facing curtain can be constructed and arranged for specific energy properties.

In some embodiments, the curtain assembly can be constructed and arranged to include a sound absorbing curtain. In one example the sound absorbing curtain is a fabric curtain. In some embodiments, the sound absorbing is installed in the rear curtain position. The sound absorbing fabric can be configured in conjunction with the air pocket defined between the paired curtains to provide improved noise reduction capability. In other embodiments, both curtains can be configured of sound absorbing material to further increase the noise reduction capability. In some embodiments, the paired curtains are attached to a single roller in the head box (discussed in greater detail below). The single roller can be operatively connected to a motor, permitting automatic raising and lowering of the paired curtains. The single roller can also be configured to operate manually to raise and lower the paired curtains.

In other embodiments, the curtain assembly can be constructed and arranged to include an energy efficient curtain. In one example, the energy efficient curtain can be a fabric curtain configured to reduce energy transferred through any window. The energy efficient curtain can be configured to reduce energy loss and/or heat gain. In some embodiments, conventional fabrics can be installed having a low energy coating, a silver lining, and known insulation properties, among other examples. The paired curtains can be configured to establish an air pocket between the curtains. The air pocket is configured to increase the energy efficiency of the curtain assembly. In some embodiments, the paired curtains are attached to a single roller in the head box. The single roller can be operated manually and/or can be motorized to raise and lower the curtains into position over a window.

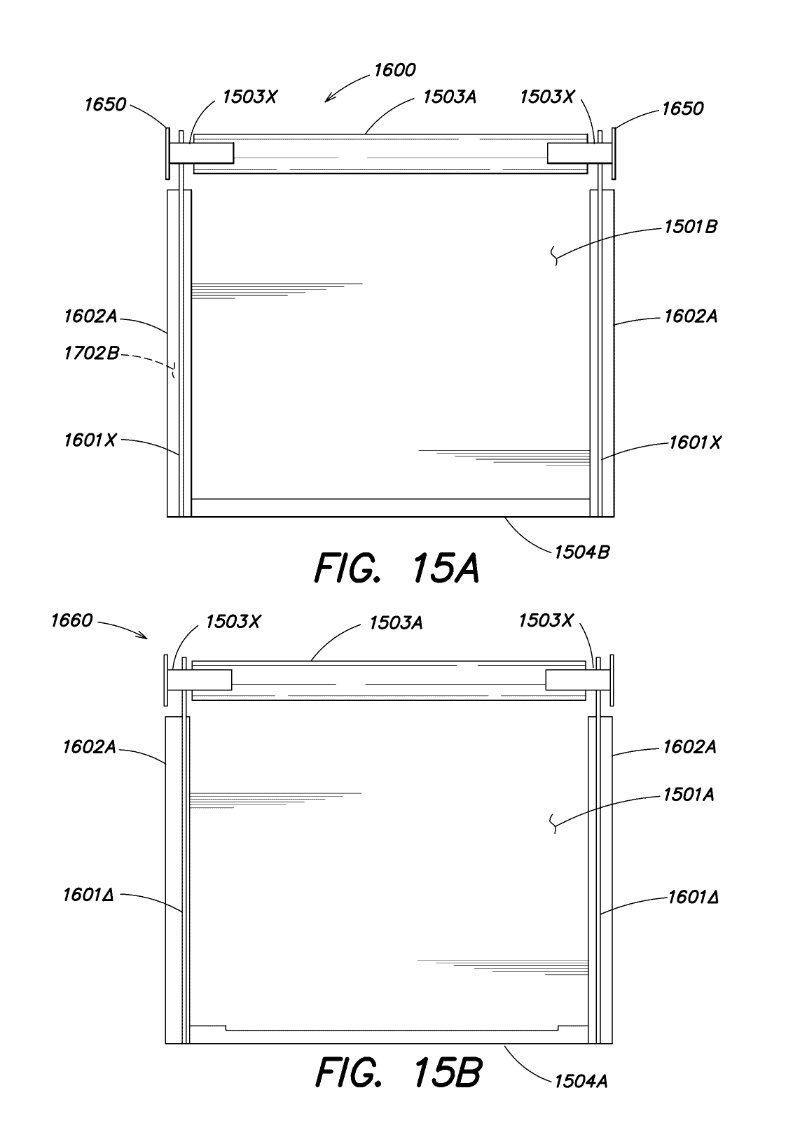

Shown in FIG. 14 is an example of a head box 1500 and associated structures for a curtain assembly. In one embodiment, head box 1500 is constructed and arranged to include a pair of curtains wound around a single roller 1503A. FIG. 15 illustrates a side view of an example head box 1500. Head box 1500 is constructed and arranged to house a single roll tube 1503A and other curtain assembly structures. Roll tube 1503A is configured to wind and unwind at least one curtain, for example, 1501B to position the curtain 1501B at or between an open and a closed position. In one embodiment, curtain 1501B can be a fabric curtain. In one example, curtain 1501B is constructed of a flat fabric panel or a substantially flat fabric panel.

Curtain 1501B can be constructed of a variety of materials. In some examples the construction material can depend on a desired energy value for the curtain assembly and/or a noise reduction capability desired. A second curtain 1501A can also be wound around roll tube 1503A housed in the head box 1500. The second curtain 1501A can be a different type of curtain than the curtain 1501A. The second curtain 1501B is arranged to face the interior of, for example, a dwelling in which the curtain assembly is installed.

In some embodiments, the second curtain is positioned towards the opening to be covered (e.g., the window) by an installed curtain assembly. The curtain 1501B can be positioned to conceal the second curtain 1501A when viewed from an interior location. For example, the curtain assembly can be positioned to cover an exterior window and the second curtain 1501A can be positioned closest to the window (a rear position), with the curtain 1501B covering the second curtain (a front position) from an interior perspective.

The second curtain can be selected based on its energy properties, including for example, a desired R value, or noise reduction capability. In some examples, this allows the curtain 1501B to be selected based on aesthetic properties. According to some embodiments, the second curtain 1501A is constructed of a low e coated fabric. Low-e coated fabric is configured to have a low energy emission ratio. Low e fabric can be constructed with metallic materials or materials having semi-conductive properties. In some examples, a fabric curtain can include a silver lining configured to improve the energy characteristics of the curtain and/or the curtain assembly. In some examples, other insulated fabric curtains can be employed. Low energy emissions curtains can be configured to limit heat and/or cold loss depending upon the environment in which the curtain assembly is installed.

The second curtain 1501A can be constructed and arranged to create an air pocket 1514 between the curtain 1501B and the second curtain 1501A. In some implementations, the air pocket improves the R value for the curtain assembly. In some embodiments, the air pocket is employed for improving noise level reduction capability of the separate curtains that make up the curtain assembly.

Roller Guide 1503B can be installed within the head box 1500 to position the second curtain 1501A closer to the opening to be covered. Further, in some embodiments roller guide 1503B can be positioned within the head box 1500 to provide the spacing between curtain 1501A and 1501B that defines a portion of air pocket 1514. In one example, roller guide 1503B is constructed having a 1.5″ diameter. In some embodiments, different roller guides having different diameters can be installed in head box 1500 to define different sized air pockets 1514. Further the diameter of the roller guide is constructed to place curtain 1501A closer to any opening covered by a curtain assembly, and to position curtain 1501B towards the interior side of the covered opening.

In one example, the dimensions of head box at 1505A and C are constructed to fit within a variety of window frames. In one example, the head box 1500 is constructed having a height of 5.5″ at 1505A and depth 1505C of 5″. Other dimensions for the height and depth of head box can be constructed according to the dimensions of window and/or window box in which the head box is installed. According to some embodiments, head box 1500 can be constructed with a closure cap 1505B configured to conceal the interior structures of head box 1500, including roll tube 1503A and roller guide 1503B from an interior side viewing position.

According to some embodiments, brush seals 1506A, B, and C are positioned within the head box 1500 and mated with curtain 1501A and second curtain 1501B to improve the air pocket defined at 1514. Brush seals 1506A, B, and C maintain contact with curtain 1501A and 1501B during operation of the curtain assembly between open and closed positions. Brush seals 1506A, B, and C resist air flow into and out of air pocket 1514. In some embodiments, brush seals 1506A, B, and C improve the integrity of air pocket 1514 increasing the R value of the curtain assembly. In other embodiments, the increased integrity of air pocket 1514 improves the noise reducing properties of the curtain assembly. In some embodiments, brush seals 1506A, B, and C can be constructed of bristles, a fabric strip, or a resilient and compressible material.

In some embodiments, a bottom rail 1504B can be attached to curtain 1501B. The bottom rail 1504B can be weighted to assist in the operation of the curtain 1501B between an open and closed position. Curtain 1501A can also be attached to bottom rail 1504A. The bottom rail 1504A can be configured with a channel 1504C configured to allow for a difference in operating length of curtains 1501A and 1501B. As curtains 1501A and B transition between an open and closed position the difference in positioning of curtains 1501A and 1501B can result in differences in operating length. Channel 1504C in bottom rail 1504A is constructed and arranged to allow for variation in the lengths of curtains 1501A and 1501B during operation. In some embodiments, bottom rail 1504A is constructed to allow curtain 1501B to slide into channel 1504C. In one example, bottom rail 1504A is constructed and arranged with a 1″ channel, providing for an operating length difference of up to 1″. Curtain 1501A is connected to bar 1510. Bar 1510 is constructed with a diameter that allows bar 1510 to move within channel 1504C but mate with an upper portion of bottom rail 1504A upon lift of the curtain 1501A.

In some embodiments, when curtain 1501A is raised bar 1510 meets with an upper portion of bottom rail 1504A. Once bar 1510 meets with an upper portion of the bottom rail, both are lifted during continued lift of the curtain. When curtain 1501A is lowered, bottom rail 1504A meets with a portion of the window frame 1550 in which head box 1500 is installed. Once bottom rail 1504A contacts the portion of window frame 1550 continued lowering of curtain 1501A allows bar 1510 to descend within channel 1504C. The spacing provided by channel 1504C enables curtains 1501A and 1501B to have different operating lengths, while maintaining a seal with between curtains 1501A and 1501B and the portion of the window frame 1550. In some embodiments, bottom bar 1504C can include a brush seal 1506D to improve the connection between bottom rail 1504C and the portion of the window frame at 1550. In some embodiments, a bottom rail 1504B can be attached to curtain 1501B. The bottom rail 1504B can be weighted to assist in the operation of curtain 1501B. Unwinding curtains 1501A and 1501B can be assisted by gravity. Increasing the weight of the bottom rails 1504A and 1504B can increase the force applied to unwind curtains 1501A-B during operation of a curtain assembly. Bottom rail 1504B can also include a brush seal (not shown).

The side boundaries for the air pocket 1514 are not shown in FIG. 14. In some embodiments, the side boundaries for the air pocket 1514 occur at guide tracks mated to curtains 1501B and 1501A. For example, a tracked curtain assembly is shown in FIG. 1D, where a curtain is held in place using a zippered edge portion that operates within a track insert held within a track guide—shown by way of example in FIG. 2. Curtain 1501B and the second curtain 1501A can operate within respective tracks, and the connection between the curtains and the tracks establish the side boundaries for the air pocket 1514.

In other embodiments, the curtain includes fabric stiffeners 1520-1534 that are spaced according to a first spacing distribution. The first spacing distribution is configured to separate the fabric stiffeners on the first curtain so that none of the fabric stiffeners on the first curtain overlap when wound around the roll tube. The second curtain also includes fabric stiffeners 1540-1552 that are spaced according to a second spacing distribution. The second spacing distribution is configured to separate the fabric stiffeners on the first curtain so that none of the fabric stiffeners on the first curtain overlap when wound around the roll tube. In further embodiments, the first and second spacing distributions are configured to prevent overlap of any of the fabric stiffeners on the first curtain and the second curtain. In one example, the first and second spacing distribution ensure that the fabric stiffeners of the first curtain and the second curtain are positioned adjacent or proximate to respective stiffeners of the other curtain.

Shown in FIGS. 15A and 15B are example frontal views of a curtain assembly and some internal structures of a head box of a curtain assembly. Frontal view 1600 illustrates a front view of curtain 1501B, roll tube 1503A, and bottom bar 1504B of FIG. 14. In some embodiments, curtain 1501B may include zipper edges 1601C that are configured to mate with structures defined by a tack insert (not shown) within track guides 1602A. In other embodiments, the curtains 1501A-B can include fabric stiffeners (not shown) and locking pins that moveably engage with ramp structures in the track guides (not shown). In examples with zipper edges, the zipper edges 1601C are configured to permit curtain 1501B to move vertically within track guide 1602A while preventing horizontal movement of curtain 1501B. During operation of roll tube 1503A curtain 1501B is held taught across a covered opening due to attachment within track guides 1602A. Paired track guides 1602 installed on both sides of the curtain provide for a lateral force to be exerted on curtain 1501B while permitting the curtain and zipper edges to move up and down in channels defined in track guides 1602A. Paired zipper edges 1601C hold curtain 1501B in place by moveably mating to track guides 1602A within a channel defined by a track insert on either side of curtain 1501B. In some embodiments, track guides 1602A are separately mated to a window frame on both sides of the frame in which a curtain assembly and/or head box is installed.

In some embodiments, mounting brackets 1650 attach to a window frame to support a head box (not shown) in which roll tube 1503A is installed. In some embodiments, offset portions 1503C of roll tube 1503A can be mated directly to mounting brackets 1650. In other embodiments, roll tube 1503A and offset portions 1503C can be mated to structures within a head box, and the head box can be mated to mounting brackets 1650. Roll tube 1503A can be constructed with an offset portion both or either end of roll tube 1503A at 1503C. The offset portions 1503C are configured to provide addition space for the width of zipper edges 1601C of curtain 1501B or for locking pins. Offset portions 1503C are constructed with diameter less than the diameter of the roll tube 1503A.

According to another embodiment, the roll tube can be constructed with half cylinder recesses that run along the roll tube, that mate with fabric stiffeners in the curtain as the curtain is wound around the roll tube.

The spacing provided by the different diameter of offset portions can be dependent on the dimensions of the opening covered by curtain assembly. In another example, the greater the height of the opening the longer the curtain and corresponding zipper edges. In some examples, the greater the length of the zipper edges the larger the volume of space the zipper edges will occupy when wound around roll tube 1503A. The greater volume occupied by zipper edges can be accommodated by increasing the length of the offset portions or reducing the diameter of the offset portion. In some embodiments, offset portion is constructed with a length of two inches. In some further embodiments, the diameter of the offset portion is constructed to be one half inch less than the diameter of the roll tube 1503A.

As curtains 1501B (FIG. 15A) and 1501A (FIG. 15B) are wound around roll tube 1503A the width of the zipper edges 1601C-D is accommodated in offset portion 1503C. In some embodiments, the width of curtain 1501A and zipper edges 1601D (FIG. 16B) is constructed to have a width less than the width of curtain 1501B and zipper edges 1601C (FIG. 16A). In other embodiments, width of curtain 1501A and zipper edges 1601D (FIG. 16B) is constructed to have a width greater than the width of curtain 1501B and zipper edges 1601C (FIG. 15A). The difference in width between the curtains permits the zipper edges of the respective curtains to be wound around roll tube 1503A in the offset portions 1503C with reduced overlap. In some examples, a two inch offset is constructed on both sides of roll tube 1503A, although in other embodiments larger offset distances are constructed to accommodate longer curtains.

Returning to FIG. 15A, zipper edges 1601C are configured to operate within a channel of track guide 1602A. In another embodiment, locking pins engage with ramp structures in the channel of track guide 1602A. In one example, zipper edges 1601C are mated to the edges of curtain 1501B. The curtain 1501B and zipper edges are configured so that the zipper edges mate with a channel of the track guide preventing horizontal movement of the curtain within track guides 1602A, but permitting vertical movement of the curtain 1501B within track guides 1602A (i.e. for raising and lowering of curtain 1501B in response to rotation of roll tube 1503A).

Track guides 1602A define channels for both curtains 1501B and 1501A (one side of an example track showing a view of both channels.

Frontal view 1660 FIG. 15B illustrates a front view of curtain 1501A, roll tube 1503A, bottom bar 1504A of FIG. 14. In some embodiments, curtain 1501A includes zipper edges 1601D that are configured to mate with structures in track guides 1602A. Zipper edges 1601C are configured to permit curtain 1501B to move vertically within track guide 1602A while holding curtain 1501A in position by exerting horizontal force on curtain 1501B. Paired zipper edges 1601D hold curtain 1501A in place by mating to track guides 1602A. In some embodiments, track guides 1602A are mated to a window frame in which a curtain assembly and/or head box is installed.

In some embodiments, mounting brackets 1650 attach to a window frame to support a head box (not shown) in which roll tube 1503A is installed. In some embodiments, offset portions 1503C can be mated directly to mounting brackets 1650. In other embodiments, roll tube 1503A and offset portions 1503C can be mated to structures within a head box, and the head box can be mated to mounting brackets 1650. Roll tube 1503A is constructed with an offset portion on either or both ends at 1503C. The offset portions 1503C are configured to provide addition space for the width of zipper edges 1601C of curtain 1501A as curtain 1501A is wound around roll tube 1503A. In some embodiments, curtain 1501B can also include zippered edge, and offset portions can be configured to accept the width of zipper edges from both curtains. Offset portions 1503C can be configured to accept the additional width of any zipper edges on curtains 1501A and 1501B.

Zipper edges 1601D are configured to operate within a channel of track guide 1602A. Zipper edges 1601C are mated to the edges of curtain 1501B so that the zipper edges mate with the channel of track guide preventing horizontal movement of the curtain within track guides 1602A, but permitting vertical movement of the curtain 1501B within track guides 1602A (i.e. raising and lowering of curtain 1501B in response to rotation of roll tube 1503A).

In some embodiments, each of the curtain channel portions can be constructed and arranged as discussed above with respect to FIGS. 1A-1D and 2. In other embodiments, curtain channel portions can exclude features discussed above with respect to Fig. FIGS. 1A-1D and 2, for example, wheel assembly 232.

In other embodiments different materials can be used to mold, cast, and/or extrude a track guide, and channels can be included as necessary to establish a desired strength for the track guide 1602A. In one example, the track guide 1602A can be constructed of steel. In another example, the track guide 1602A can be constructed of plastic. In yet another, exterior portions of track guide 1602A can be composed of aluminum and the interior track inserts can be constructed of plastic.

The material selected and the dimensions of track guide 1602A can vary depending upon a given installation site. Materials can be selected based on aesthetic as well as based on structural considerations. Further, different materials used to construct the track guide 1602A can require different dimensions and/or permit smaller installation dimensions. In some embodiments, dimensions of the opening to be covered by the curtain assembly can dictate the dimensions of the head box and internal structures described. For purposes of clarity not all structures have been explicitly referenced, for example, where the structures are the same or substantially similar to other described structures.

One should appreciate that the present invention is not limited in its application to the details of construction and the arrangement of components set forth in the foregoing description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A curtain assembly comprising:
a curtain selectably moveable between an open position and a closed position;
a track guide having a first and second opposed sides, wherein the first and second sides define a plane of operation for the curtain as it moves between the open position and the closed position;
a plurality of stiffeners disposed within the curtain, the stiffeners constructed and arranged of a cylindrical member;
a roll tube configured to wind the curtain and the plurality of stiffeners around the roll tube and unwind the plurality of stiffeners into the track guide; and
an entry guide sub-assembly constructed and arranged to guide ends of the stiffeners into respective first and second channels within the first and the second opposed sides of the track guide.

2. The curtain assembly of claim 1, wherein the entry guide sub-assembly engages locking pins at both ends of each of the plurality of stiffeners.

3. The curtain assembly of claim 2, wherein the locking pins moveably engage at respective first and second opposed interior portions of the track guide.

4. The curtain assembly of claim 2, wherein each of the first and second opposed interior portions of the track guide define an open channel for receiving the curtain and fabric stiffener.

5. The curtain assembly of claim 4, wherein the first and second opposed interior portions of the track guide each include a first and second internal flange extending partially into the open channel.

6. The curtain assembly of claim 5, where each of the first and second internal flange extend perpendicular to a respective outer edge of one of the opposed sides of the track guide.

7. The curtain assembly of claim 6, wherein the first flange includes at least one securing rail constructed and arranged to moveably engage the fabric stiffener.

8. The curtain assembly of claim 7, wherein the securing rail extends from the first flange.

9. The curtain assembly of claim 8, wherein the securing rail extends perpendicular to the first flange.

10. The curtain assembly of claim 7, wherein the locking pins of the fabric stiffener includes at least one engagement surface the extends along the securing rail.

11. The curtain assembly of claim 7, wherein the security rail includes a ramp portion that guides a respective locking pin into engagement with the securing rail.

12. The curtain assembly of claim 8, wherein the locking pin includes an inner portion constructed with a diameter less than the spacing between the first and second flange.

13. The curtain assembly of claim 1, wherein the plurality of stiffeners are disposed within the curtain according to a first spacing, wherein the first spacing is constructed and arranged such that when wound around the roll tube no overlap between the plurality of stiffeners occurs.

14. The curtain assembly of claim 13, further comprising a headbox surrounding the roll tube and curtain when wound around the roll tube, wherein the dimensions of headbox are constructed and arranged to house the roll tube and curtain with clearance of less than one width of a largest stiffener disposed in the curtain when the curtain is wound around the roll tube.
